(19) United States
(12) Patent Application Publication
(10) Pub. No.: US 2026/0238336 A1
(43) Pub. Date: Aug. 13, 2026

(54) LOGICAL SPLIT OF BASE STATION FUNCTION BETWEEN NON-TERRESTRIAL NETWORK (NTN) GATEWAY AND NTN PAYLOAD

(71) Applicant: QUALCOMM Incorporated, San Diego, CA (US)

(72) Inventors: Bharat SHRESTHA, San Diego, CA (US); Haris ZISIMOPOULOS, London (GB); Prasada Veera Reddy KADIRI, San Diego, CA (US); Geetha Priya RAJENDRAN, Bangalore (IN); Umesh PHUYAL, San Diego, CA (US); Alberto RICO ALVARINO, San Diego, CA (US)

(21) Appl. No.: 19/471,557

(22) PCT Filed: May 7, 2024
(86) PCT No.: PCT/US2024/028131

§ 371 Date: Oct. 1, 2025

(30) Foreign Application Priority Data
May 10, 2023 (GR) 20230100375

(51) Int. Cl. H04B 7/185

(52) U.S. Cl. CPC H04B 7/18541

(57) ABSTRACT

Certain aspects of the present disclosure provide a method for wireless communications by a non-terrestrial network (NTN) gateway. The method includes communicating with an access and mobility management function (AMF) of a core network; receiving a path switch request message from a target NTN payload, the path switch request message indicating to switch a downlink data path of a user equipment (UE) from a source NTN payload to the target NTN payload; after receiving the path switch request message, sending a path switch request acknowledge message to the target NTN payload; and after sending the path switch request acknowledge message, communicating user data of the UE with the target NTN payload.

### CROSS-REFERENCE TO RELATED APPLICATIONS

This application claims the benefit of and priority to Greek Patent Application No. 20230100375 filed May 10, 2023, the entire contents of which are incorporated herein by reference.

### INTRODUCTION

### Field of the Disclosure

Aspects of the present disclosure relate to wireless communications, and more particularly, to techniques for non-terrestrial network wireless communications.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a non-terrestrial network (NTN) gateway. The method includes communicating with an access and mobility management function (AMF) of a core network; receiving a path switch request message from a target NTN payload, the path switch request message indicating to switch a downlink data path of a user equipment (UE) from a source NTN payload to the target NTN payload; after receiving the path switch request message, sending a path switch request acknowledge message to the target NTN payload; and after sending the path switch request acknowledge message, communicating user data of the UE with the target NTN payload.

Another aspect provides a method for wireless communications in a non-terrestrial network (NTN). The method includes, by an NTN gateway, communicating with an AMF of a core network over an NG interface that is a point-to-point interface between the NTN gateway and the AMF; processing an NG application protocol (NGAP) header of a first packet communicated between the NTN gateway and the AMF; processing a stream control transmission protocol (SCTP) header of the first packet; and processing an Internet protocol (IP) header of the first packet. The method further includes, by an NTN payload, communicating with a UE over a Uu interface; processing a packet data convergence protocol (PDCP) header of a second packet communicated between the NTN payload and the UE, the second packet comprising a radio resource control (RRC) message; processing a radio link control (RLC) protocol header of the second packet; processing a medium access control (MAC) header of the second packet; processing the RRC message; and communicating with the NTN gateway over a satellite radio interface (SRI) between the NTN payload and the NTN gateway.

Other aspects provide one or more apparatuses operable, configured, or otherwise adapted to perform any one or more of, including all or portions of, the aforementioned methods and/or those described elsewhere herein. For example, the one or more of the aforementioned methods and/or those described elsewhere herein may be performed by only one apparatus or be performed in a distributed fashion across multiple apparatuses.

Other aspects provide one or more non-transitory, computer-readable media comprising instructions that, when executed by one or more processors of one or more apparatuses, cause the one or more apparatuses to perform any one or more of, including all or portions of, the aforementioned methods as well as those described elsewhere herein. For example, instructions that cause one or more apparatuses to perform any one or more of, including all or portions of, the aforementioned methods as well as those described elsewhere herein may be included on only one computer-readable medium or be included in a distributed fashion across multiple computer-readable media. Further, instructions executed by one or more processors may be executed by only one processor or by multiple processors in a distributed fashion. Further, each apparatus of the one or more apparatuses may include one processor or multiple processors. The one or more of the aforementioned methods and/or those described elsewhere herein may be performed by only one apparatus or be performed in a distributed fashion across multiple apparatuses.

Other aspects provide one or more computer program products embodied on one or more computer-readable storage media comprising code for performing the aforementioned methods as well as those described elsewhere herein.

Other aspects provide one or more apparatuses comprising means for performing the aforementioned methods as well as those described elsewhere herein. For example, the one or more of the aforementioned methods and/or those described elsewhere herein may be performed by only one apparatus or be performed in a distributed fashion across multiple apparatuses.

By way of example, an apparatus may comprise a processing system (e.g., including one or more processors), a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts an example regenerative payload architecture of a non-terrestrial network (NTN).

FIG. 6 depicts an example control plane protocol architecture for an NTN gateway and an NTN payload.

FIG. 7 depicts another example control plane protocol architecture for an NTN gateway and an NTN payload.

FIG. 8 depicts an example user plane protocol architecture for an NTN gateway and an NTN payload.

FIG. 9 depicts another example user plane protocol architecture for an NTN gateway and an NTN payload.

FIG. 10 illustrates a call flow for a handover of a UE from a source NTN payload to a target NTN payload.

FIG. 11 illustrates a call flow for a connection re-establishment of a UE from a source NTN payload to a target NTN payload.

FIG. 12 depicts a method for wireless communications.

FIG. 13 depicts another method for wireless communications.

FIG. 14 depicts another method for wireless communications.

FIG. 15 depicts aspects of an example communications device.

FIG. 16 depicts aspects of an example communications device.

FIG. 17 depicts aspects of an example communications device.

### DETAILED DESCRIPTION

Aspects of the present disclosure provide apparatuses, methods, processing systems, and computer-readable mediums for splitting base station functionality between a non-terrestrial network (NTN) gateway and an NTN payload, which may be part of an NTN system. An NTN gateway refers to a ground based station providing connectivity to an NTN payload using a feeder link. An NTN payload refers to a spaceborne (e.g., satellite) or airborne (e.g., airship, balloon, etc.) platform that provides connectivity to user equipments (UEs). For example, downlink packets sent from a core network to a UE may be sent from the core network to an NTN gateway, which sends the packets to an NTN payload, which sends the packets to the UE. Uplink packets sent from the UE to the core network may be sent from the UE to the NTN payload, which sends the packets to the NTN gateway, which sends the packets to the core network.

In some cases, an NTN is configured to operate using a transparent payload architecture. In a transparent payload architecture, the NTN payload is configured to mirror received signals and transmit an amplified version of the signal, and perform frequency conversion between uplink and downlink frequencies. For example, the NTN payload may include a low noise amplifier (LNA) to amplify received signals, a mixer to convert the frequency of the signals, and a high-power amplifier (HPA) to amplify and transmit the signals.

In other cases, an NTN is configured to operate using a regenerative payload architecture. In a regenerative payload architecture, the NTN payload is able to perform on-board processing (OBP) of signals, such as encoding, decoding, etc. Accordingly, in a regenerative payload architecture, functionality of a base station (BS) can be added on-board the NTN payload. However, there still remains the technical problem of how to divide the BS functionality between the NTN payload and the NTN gateway so as to achieve efficient communications in the NTN.

Certain aspects herein relate to use of a regenerative payload architecture. In particular, certain aspects herein logically split the functionality of a BS between an NTN gateway and an NTN payload. In certain aspects, an NTN payload includes functionality for processing (e.g., encoding, decoding, encapsulating, decapsulating, generating, etc.) packets communicated (e.g., received or transmitted) over an interface (e.g., Uu interface) between a UE and the NTN payload. The interface between the UE and the NTN payload may be a point-to-point interface between the UE and the NTN payload (e.g., the interface terminates at each of the UE and the NTN payload, and not at the NTN gateway). Further, the NTN gateway includes functionality for processing packets communicated over one or more interfaces (e.g., NG interface, such as NG user plane (NG-U) and/or NG control plane (NG-C), etc.) between the core network (e.g., access and mobility management function (AMF), user plane function (UPF), etc.) and the NTN gateway. The one or more interfaces between the NTN gateway and the core network may be point-to-point interfaces (e.g., the interface terminates at each of the NTN gateway and the core network, and not at the NTN payload).

In certain aspects, to setup the interface (e.g., NG interface) between the NTN gateway and the core network, the NTN gateway sends a setup request message (e.g., NG setup request message) to the AMF to establish the interface. In certain aspects, after sending the setup request message, the NTN gateway receives from the AMF a setup response message (e.g., NG setup response message) from the AMF, wherein the setup response message includes an identifier of the NTN gateway.

Though certain aspects are discussed with respect to a Uu interface and an NG interface, the techniques herein are applicable to other suitable interfaces between a UE and an NTN payload and between an NTN gateway and a core network.

For example, the NTN payload may be configured to perform processing (e.g., encapsulation of packets, decapsulating packets, generating messages, etc.) of one or more layers of a protocol stack associated with the Uu interface, such as a radio resource control (RRC) layer, a packet data convergence protocol (PDCP) layer, a radio link control (RLC) layer, a medium access control (MAC), and a physical (PHY) layer. The NTN gateway may be configured to perform processing of one or more layers of a protocol stack associated with an NG control plane interface, such as an NG application protocol (NGAP) layer, a stream control transmission protocol (SCTP) layer, an Internet protocol (IP) layer, a data link (L2) layer, and a physical (L1) layer. The NTN gateway may also be configured to perform processing of one or more layers of a protocol stack associated with an NG user plane interface, such as a general packet radio system (GPRS) tunneling protocol user plane (GTP-U) layer, a user datagram protocol (UDP) layer, an IP layer, an L2 layer, and an L1 layer. The NTN gateway may not be configured to process layers of the protocol stack associated with the Uu interface, such as not being configured to process the RRC layer and PDCP layer. For example, the NTN gateway may be configured to not perform any RRC layer or PDCP layer processing of any packets (e.g., all) communicated between an NTN payload and a UE. The NTN gateway not being configured to process the RRC layer and PDCP layer may reduce computational complexity at the NTN gateway side, allowing for more efficient operation of the NTN gateway.

One technical effect and advantage of splitting the functionality of the BS such that the NTN gateway handles the NG interface, while the NTN payload handles the Uu interface, is that packets communicated between the NTN payload and the UE can be processed at the NTN payload, without having to pass such packets to the NTN gateway for processing. Accordingly, less traffic is required on the feeder link between the NTN payload and NTN gateway, reducing congestion on the feeder link. Another technical effect and advantage of splitting the functionality of the BS such that the NTN gateway handles the NG interface, while the NTN payload handles the Uu interface, is that packets communicated between the NTN gateway and the core network can be processed at the NTN gateway, without having to pass such packets to the NTN payload for processing. Accordingly, less traffic is required on the feeder link between the NTN payload and NTN gateway, reducing congestion on the feeder link.

Another technical problem with a regenerative payload architecture is the issue of UE mobility between NTN payloads. In particular, as NTN payloads move, UEs may need to frequently switch connections between different NTN payloads to remain connected to the core network. Such frequent connection switches may lead to frequent path switches and NGAP setup procedures being performed each time the UE connection switches. The path switches and NGAP setup procedures introduce communication overhead, leading to network congestion, and latency in communications to perform the procedures.

Certain aspects herein further provide techniques for mobility of a UE between a first NTN payload in communication with an NTN gateway and a second NTN payload in communication with the same NTN gateway. For example, certain aspects provide techniques for a UE to handover from the first NTN payload to the second NTN payload. As another example, certain aspects provide techniques for a UE to re-establish a connection (e.g., RRC connection) with the second NTN payload after a radio link failure (RLF) with the first NTN payload. In particular, certain aspects provide an NTN gateway configured to process a path switch request received at the NTN gateway from the second NTN payload, such as without involving the core network (e.g., the AMF), or without changing a path (e.g., downlink path) between the NTN gateway and the AMF. A path switch request procedure is meant to establish a UE associated signaling connection (e.g., over a Uu interface and NG interface) to the core network, and if applicable, request the switch of the downlink termination point (e.g., radio access network (RAN) side termination) of the NG-U interface toward a new termination point. In particular, as the NG interface is between the core network and the NTN gateway, where the NTN gateway is the downlink termination point (e.g., RAN side termination point), the NG interface does not need to be re-established when the UE switches from the first NTN payload to the second NTN payload as the NG interface termination point has not changed. Rather, the NTN gateway changes the connection path for the UE from the first NTN payload to the second NTN payload, without changing the connection path between the NTN gateway and the core network.

One technical effect and advantage of configuring the NTN gateway to process a path switch request, such as without involving the core network, is that NGAP setup procedures do not need to be performed in response to the path switch request, reducing congestion on the connection between the NTN gateway and the core network, and reducing communications latency.

Another technical problem with a regenerative payload architecture is the issue of loss of communication between the NTN gateway and NTN payload. For example, the feeder link between the NTN gateway and the NTN payload may not always be available as the NTN payload moves and connectivity with the NTN gateway is lost. Accordingly, UE data (e.g., control signals, user plane data, UE context information, etc.) to be communicated to the NTN gateway may be dropped when the NTN payload does not have connectivity with the NTN gateway. Dropped data may require overhead for the UE to resend data, or cause timeout of procedures such as standalone registration/attach, RRC setup, RRC resume, or RRC reestablishment procedures.

Certain aspects herein provide an NTN payload configured to store UE data, such as when a feeder link with an NTN gateway is not available, and further forward the stored UE data to an NTN gateway when a feeder link with the NTN gateway is available. One technical effect and advantage of configuring the NTN payload to store and forward UE data is that UE data is not dropped when the NTN payload does not have connectivity with the NTN gateway, thereby reducing overhead for the UE having to resend data.

Certain aspects herein provide for configuring a UE with an indication of a delay in communication between an NTN payload and an NTN gateway. In certain aspects, the interface used for communication between the NTN payload and the NTN gateway is referred to as a satellite radio interface (SRI). Accordingly, the delay in communication between an NTN payload and an NTN gateway may be referred to as an SRI delay. The SRI delay may be configured based on the time that a message takes to be communicated between an NTN gateway and an NTN payload, also including time accounting for feeder link unavailability (referred to as a feeder link discontinuous gap length). The NTN payload may configure the UE with the indication of the SRI delay such as by sending the indication in signaling, such as via broadcast or such as UE specific signaling (e.g., an RRC message or a non-access stratum (NAS) message). The SRI delay may be determined and/or updated by the core network, and signaling from the core network via the NTN payload. In certain aspects, the SRI delay may be indicated in an attach accept message.

In certain aspects, the UE is configured to use the SRI delay to set one or more timers to buffer/wait for response messages. For example, the UE may send a request (e.g., attach request, RRC setup request, RRC resume request, RRC reestablishment request, registration request, etc.) and have a timer or buffer to wait for a response (e.g., attach response, RRC setup response, RRC resume response, RRC reestablishment response, registration response, etc.) before determining the request is unsuccessful (e.g., and retrying the request). The length of the timer or buffer accordingly may be set based on the SRI delay. One technical effect and advantage of configuring the NTN payload to configure the UE with the SRI delay is that the UE is less likely to timeout while waiting for a response, therefore reducing signaling overhead and latency for having to retry a request.

Further, in certain aspects, where a first NTN payload is storing UE data, and the UE establishes a connection with a second NTN payload, such as due to mobility, the first NTN payload may forward the UE data to the NTN gateway, which forward the data to the second NTN payload. One technical effect and advantage of configuring the NTN payload to forward UE data via the NTN gateway to another NTN payload is that even if the first NTN payload is unable to communicate with the second NTN payload, the communication via the NTN gateway allows UE data to avoid being dropped, thereby reducing signaling overhead and latency for having to resend the UE data.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

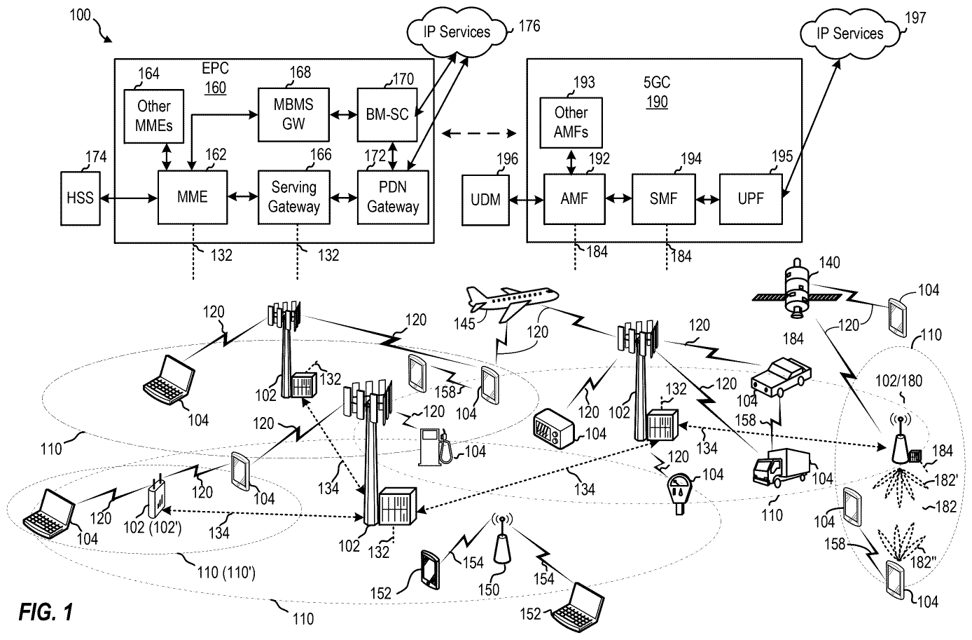

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and vehicle 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

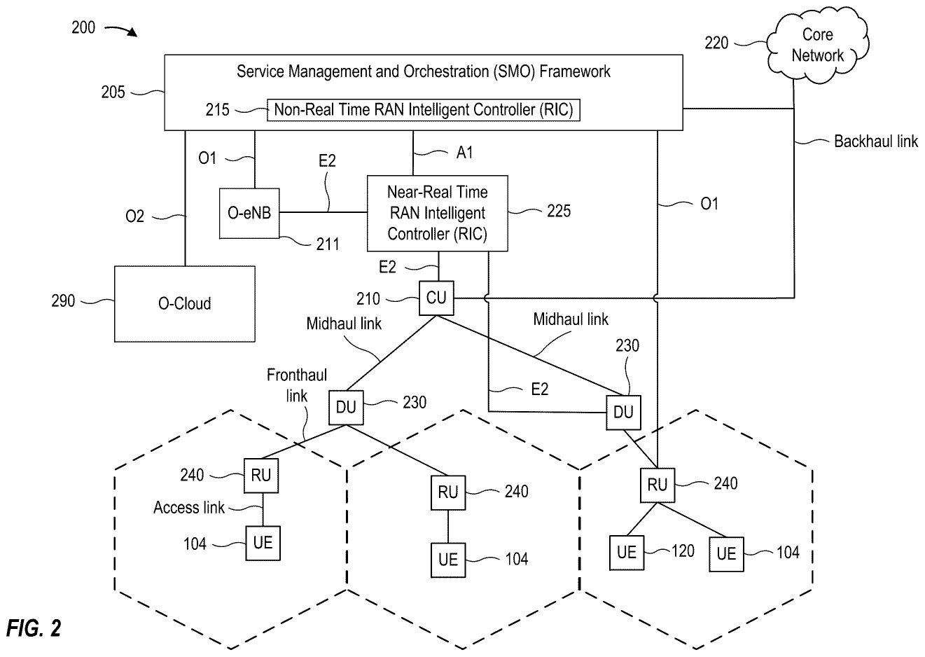

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

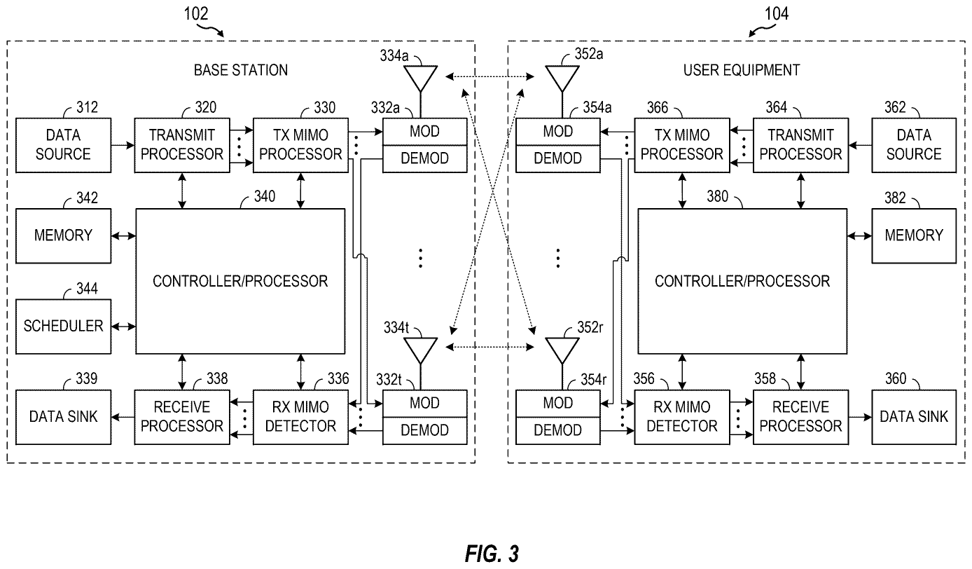

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

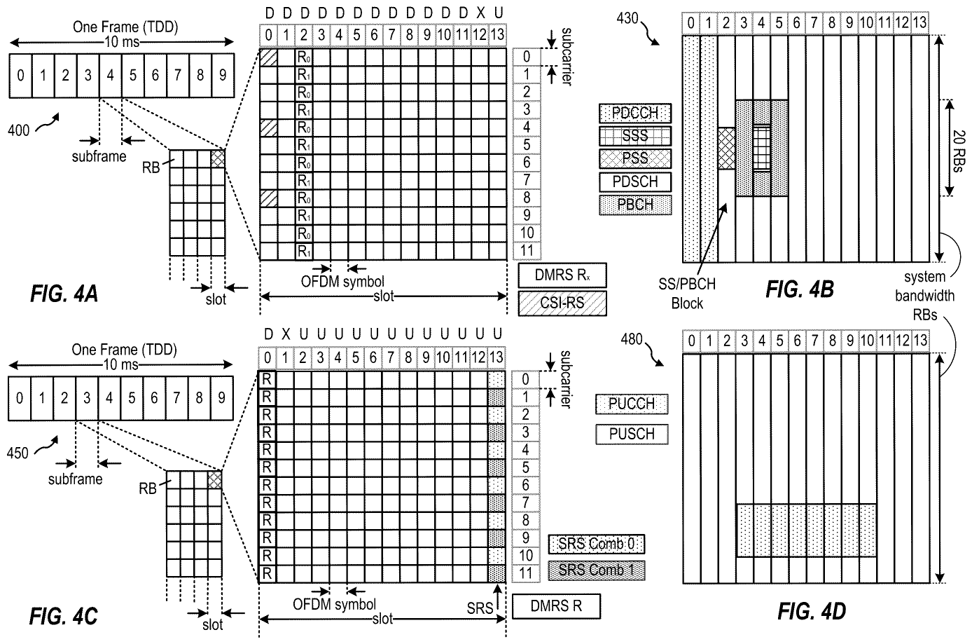

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 24×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Regenerative Payload Architecture of an NTN

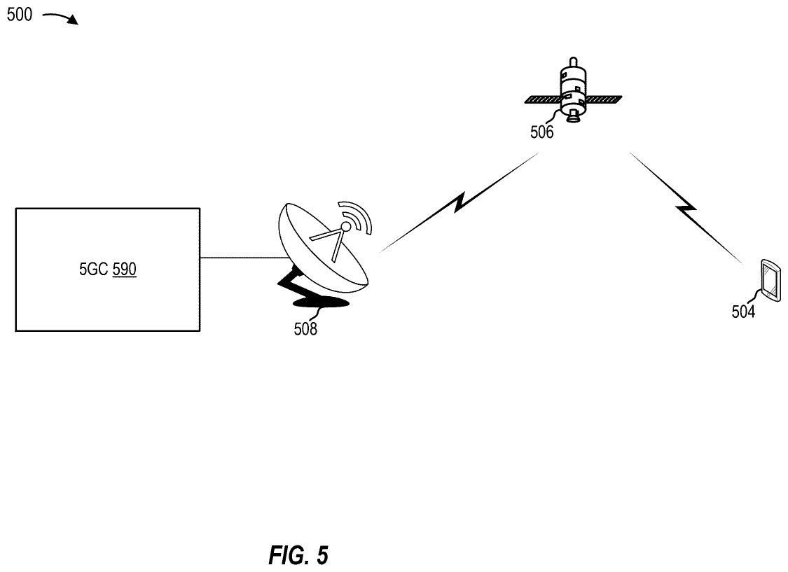

FIG. 5 depicts an example regenerative payload architecture of an NTN 500. As shown, the NTN 500 includes a 5GC network 590 (e.g., 5GC network 190 of FIG. 1). The NTN 500 further includes an NTN gateway 508. The NTN gateway 508 may communicate with the 5GC network 590 via one or more interfaces, such as an NG interface, such as over a wired and/or wireless connection. The NTN 500 further includes an NTN payload 506, shown in the example as a satellite. The radio link between the NTN gateway 508 and the NTN payload 506 may be referred to as a feeder link. Accordingly, the NTN payload 506 and NTN gateway 508 may communicate wirelessly with each other over the feeder link. The NTN 500 further includes a UE 504 (e.g., UE 104 of FIG. 1). The NTN payload 506 may communicate with the UE 504 wirelessly via an interface, such as a Uu interface. Accordingly, NTN 500 provides a communication path between the 5GC network 590 and the UE 504 via the NTN gateway 508 and the NTN payload 506.

### Aspects Related to Split of BS Functionality Between NTN Payload and NTN Gateway

Certain aspects herein logically split the functionality of a BS between an NTN gateway and an NTN payload. In certain aspects, an NTN payload includes functionality for processing packets communicated (e.g., received or transmitted) over a an interface (e.g., Uu interface) between a UE and the NTN payload. Further, the NTN gateway includes functionality for processing packets communicated over one or more interfaces (e.g., NG interface, such as NG user plane (NG-U) and/or NG control plane (NG-C), etc.) between the core network (e.g., access and mobility management function (AMF), user plane function (UPF), etc.) and the NTN gateway.

### Aspects Related to Control Plane Architecture

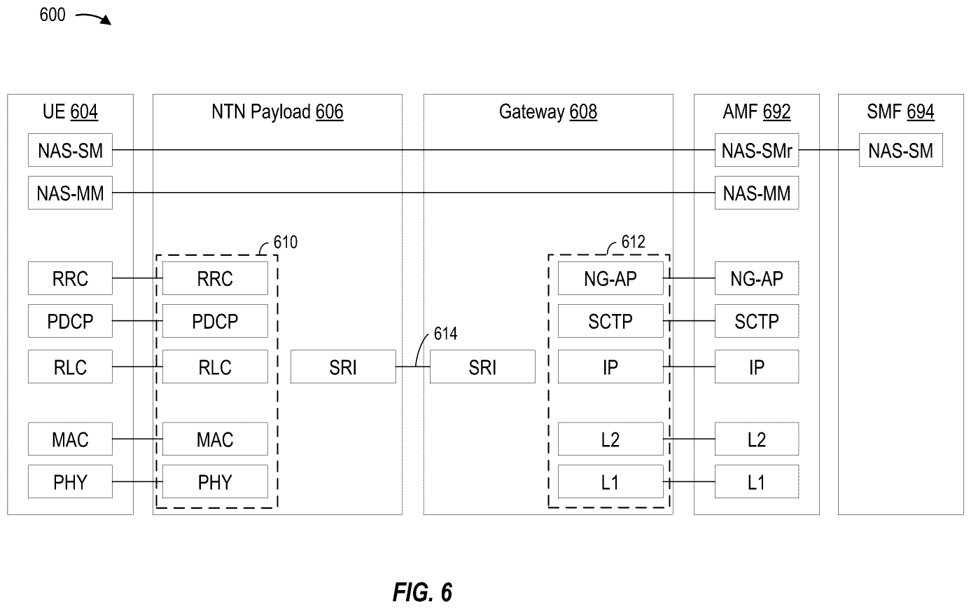

FIG. 6 depicts an example control plane protocol architecture 600 for an NTN gateway and an NTN payload. As shown, NTN payload 606 (e.g., NTN payload 506 of FIG. 5) is configured to process one or more layers of a protocol stack 610 associated with the interface (e.g., Uu interface) between the NTN payload 606 and the UE 604 (e.g., UE 104 of FIG. 1). In particular, the protocol stack 610, as shown, includes an RRC layer, a PDCP layer, an RLC layer, a MAC layer, and a PHY layer.

For example, for downlink packets, such as RRC messages, transmitted from NTN payload 606 to UE 604, NTN payload 606 is configured to generate the packets using the protocol stack 610. In certain aspects, NTN payload 606 generates an RRC message at the RRC layer. In certain aspects, the RRC message may be generated based on control data received at NTN payload 606 from AMF 692 (e.g., AMF 192 of FIG. 1), SMF 694 (e.g., SMF 194 of FIG. 1), or another core network entity, via NTN gateway 608 (e.g., NTN gateway 508). NTN payload 606 further encapsulates the packet by adding a PDCP header to the packet at the PDCP layer. The NTN payload 606 further encapsulates the packet by adding an RLC header to the packet at the RLC layer. One or more packets with an RLC header may be concatenated and encapsulated with a MAC header at the MAC layer. Further, in certain aspects, NTN payload 606 adds a cyclic redundancy check (CRC) to the packet at the PHY layer. NTN payload 606 transmits the packet to UE 604.

As another example, for uplink packets, such as RRC messages, received at NTN payload 606 from UE 604, NTN payload 606 is configured to process the packets using protocol stack 610. For example, NTN payload 606 performs a CRC of the packet at the PHY layer and decapsulates the packet by removing the MAC header at the MAC layer. One or more RLC packets are decapsulated by removing the RLC header(s) at the RLC layer. NTN payload 606 further decapsulates each packet by removing the PDCP header at the PDCP layer. The resulting RRC message may be processed by NTN payload 606, or encoded by NTN payload 606 and forwarded to NTN gateway 608.

As shown, NTN gateway 608 is configured to process one or more layers of a protocol stack 612 associated with the interface (e.g., NG interface) between the NTN gateway 608 and the AMF 692 (or other core network entity). In particular, the protocol stack 612, as shown, includes an NGAP layer, an SCTP layer, an IP layer, an L2 layer, and an L1 layer.

For example, for downlink packets, such as NGAP messages, transmitted from NTN gateway 608 to AMF 692, NTN gateway 608 is configured to generate the packets using the protocol stack 612. In certain aspects, NTN gateway 608 generates an NGAP packet by encapsulating control data with an NGAP header at the NGAP layer. NTN gateway 608 further encapsulates the packet with an SCTP header at the SCTP layer. NTN gateway 608 further encapsulates the packet with an IP header at the IP layer. In certain aspects, NTN gateway 608 encapsulates the packet with an L2 header, such as at the L2 layer. In certain aspects, NTN gateway 608 adds a CRC to the packet at the L1 layer. NTN gateway 608 transmits the packet to AMF 692.

As another example, for uplink packets, such as NGAP messages, received at NTN gateway 608 from AMF 692, NTN gateway 608 is configured to process the packets using protocol stack 612. For example, in certain aspects, NTN gateway 608 performs a CRC of the packet at the L1 layer and decapsulates the packet by removing the MAC header at the L2 layer. NTN gateway 608 decapsulates the packet by removing the IP header at the IP layer. NTN gateway 608 further decapsulates the packet by removing the SCTP header at the SCTP layer. NTN gateway 608 further decapsulates the packet by removing the NGAP header at the NGAP layer. The resulting NGAP message/payload may be processed by NTN gateway 608, or encoded by NTN gateway 608 and forwarded to NTN payload 606.

NTN gateway 608 is further configured to communicate with NTN payload 606 over an SRI 614. The SRI 614 may be any suitable proprietary or non-proprietary interface, and may have one or more protocol layers, implemented at each of NTN payload 606 and NTN gateway 608. SRI 614 may be a point-to-point interface between NTN payload 606 and NTN gateway 608 (e.g., SRI 614 terminates at each of NTN payload 606 and NTN gateway 608).

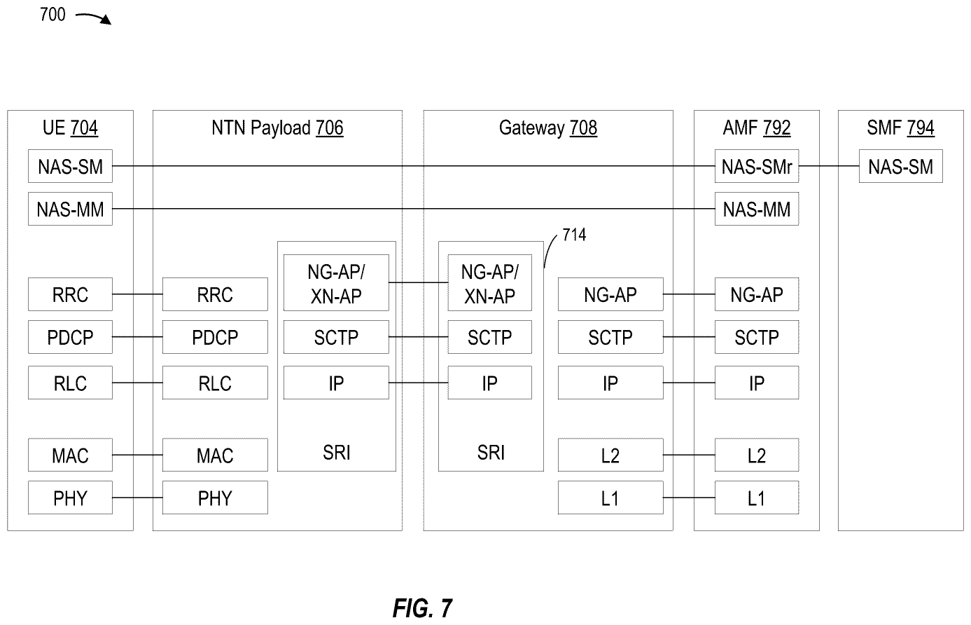

FIG. 7 depicts another example control plane protocol architecture 700 for an NTN gateway and an NTN payload. The control plane protocol architecture 700 is similar to the control plane architecture 600 of FIG. 6. For example, in certain aspects UE 704 corresponds to UE 604, NTN payload 706 corresponds to NTN payload 606, NTN gateway 708 corresponds to NTN gateway 608, AMF 792 corresponds to AMF 692, and SMF 794 corresponds to SMF 694. Control plane protocol architecture 700 further includes an SRI 714 similar to SRI 614. However, SRI 714 is implemented using specific protocol layers as shown in FIG. 7. For example, SRI 714 may be implemented as an Xn interface and/or an NG interface. In particular, each of NTN payload 706 and NTN gateway 708 implement a protocol stack for the SRI with an NGAP or XnAP layer (similar to the NGAP layer of protocol stack 612 of FIG. 6), an SCTP layer (similar to the SCTP layer of protocol stack 612 of FIG. 6), and an IP layer (similar to the IP layer of protocol stack 612 of FIG. 6). In certain aspects, to setup the interface (e.g., NG interface) between the NTN gateway 708 and the NTN payload 706, the NTN payload 706 sends a setup request message (e.g., NG setup request message) to the NTN gateway 708 to establish the interface. In certain aspects, after receiving the setup request message, the NTN gateway 708 sends a setup response message (e.g., NG setup response message) to the NTN payload 706, wherein the setup response message includes an identifier of the NTN payload 706.

### Aspects Related to User Plane Architecture

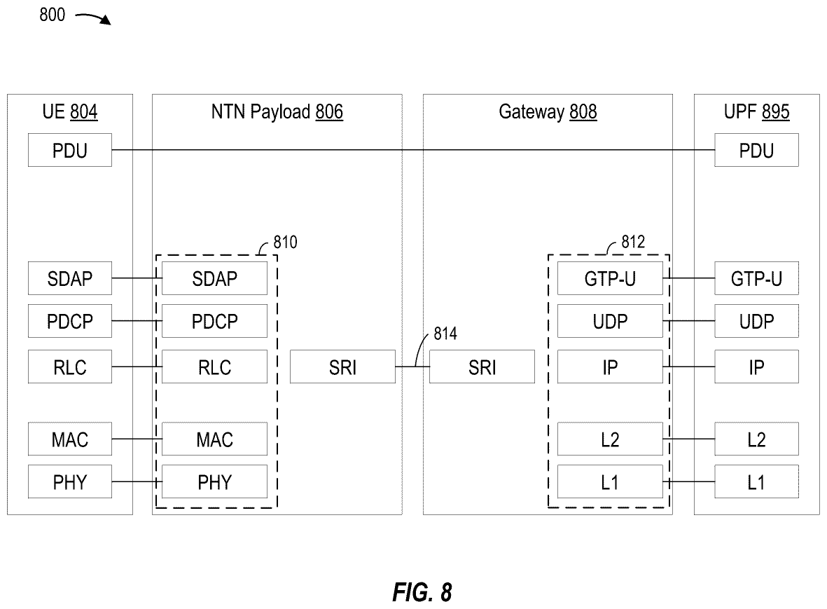

FIG. 8 depicts an example user plane protocol architecture 800 for an NTN gateway and an NTN payload. As shown, NTN payload 806 (e.g., NTN payload 506 of FIG. 5) is configured to process one or more layers of a protocol stack 810 associated with the interface (e.g., Uu interface) between the NTN payload 806 and the UE 804 (e.g., UE 104 of FIG. 1). In particular, the protocol stack 810, as shown, includes an SDAP layer, a PDCP layer, an RLC layer, a MAC layer, and a PHY layer.

For example, for downlink packets, such as IP packets, transmitted from NTN payload 806 to UE 804, NTN payload 806 is configured to generate the packets using the protocol stack 810. In certain aspects, NTN payload 806 encapsulates an IP packet at the SDAP layer with an SDAP header. In certain aspects, the IP packet may be generated based on user data received at NTN payload 806 from UPF 895 (e.g., UPF 195 of FIG. 1) or another core network entity, via NTN gateway 808 (e.g., NTN gateway 508). NTN payload 806 further encapsulates the packet by adding a PDCP header to the packet at the PDCP layer. The NTN payload 806 further encapsulates the packet by adding an RLC header to the packet at the RLC layer. One or more packets with an RLC header may be concatenated and encapsulated with a MAC header at the MAC layer. Further, in certain aspects, NTN payload 806 adds a CRC to the packet at the PHY layer. NTN payload 806 transmits the packet to UE 804.

As another example, for uplink packets, such as IP packets, received at NTN payload 806 from UE 804, NTN payload 806 is configured to process the packets using protocol stack 810. For example, NTN payload 806 performs a CRC of the packet at the PHY layer and decapsulates the packet by removing the MAC header at the MAC layer. One or more RLC packets are decapsulated by removing the RLC header(s) at the RLC layer. NTN payload 806 further decapsulates each packet by removing the PDCP header at the PDCP layer. NTN payload 806 further decapsulates each packet by removing the SDAP header at the SDAP layer. The resulting IP packet may be processed by NTN payload 806, or encoded by NTN payload 806 and forwarded to NTN gateway 808.

As shown, NTN gateway 808 is configured to process one or more layers of a protocol stack 812 associated with the interface (e.g., NG interface) between the NTN gateway 808 and the UPF 895 (or other core network entity). In particular, the protocol stack 812, as shown, includes a GTP-U layer, a UDP layer, an IP layer, an L2 layer, and an L1 layer.

For example, for downlink packets, such as IP packets, transmitted from NTN gateway 808 to UPF 895, NTN gateway 808 is configured to generate the packets using the protocol stack 812. In certain aspects, NTN gateway 808 encapsulates an IP packet including user data (such as from NTN payload 806) with a GTP-U header at the GTP-U layer. NTN gateway 808 further encapsulates the packet with a UDP header at the UDP layer. NTN gateway 808 further encapsulates the packet with an IP header at the IP layer. In certain aspect, NTN gateway 808 encapsulates the packet with an L2 header, such as at the L2 layer. In certain aspects, NTN gateway 808 adds a CRC to the packet at the L1 layer. NTN gateway 808 transmits the packet to UPF 895.

As another example, for uplink packets, such as IP packets, received at NTN gateway 808 from UPF 895, NTN gateway 808 is configured to process the packets using protocol stack 812. For example, in certain aspects, NTN gateway 808 performs a CRC of the packet at the L1 layer and decapsulates the packet by removing the MAC header at the L2 layer. NTN gateway 808 decapsulates the packet by removing the IP header at the IP layer. NTN gateway 808 further decapsulates the packet by removing the UDP header at the UDP layer. NTN gateway 808 further decapsulates the packet by removing the GTP-U header at the GTP-U layer. The resulting IP packet may be processed by NTN gateway 808, or encoded by NTN gateway 808 and forwarded to NTN payload 806.

NTN gateway 808 is further configured to communicate with NTN payload 806 over an SRI 814. The SRI 814 may be any suitable proprietary or non-proprietary interface, and may have one or more protocol layers, implemented at each of NTN payload 806 and NTN gateway 808. SRI 814 may be a point-to-point interface between NTN payload 806 and NTN gateway 808.

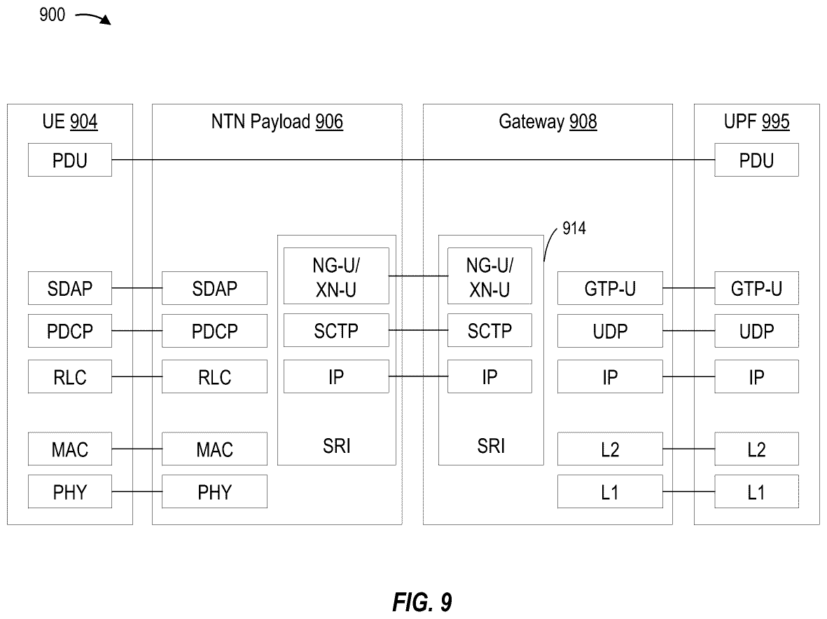

FIG. 9 depicts another example user plane protocol architecture 900 for an NTN gateway and an NTN payload. The control plane protocol architecture 900 is similar to the control plane architecture 800 of FIG. 8. For example, in certain aspects UE 904 corresponds to UE 804, NTN payload 906 corresponds to NTN payload 806, NTN gateway 908 corresponds to NTN gateway 808, and UPF 995 corresponds to UPF 895. Control plane protocol architecture 900 further includes an SRI 914 similar to SRI 814. However, SRI 914 is implemented using specific protocol layers as shown in FIG. 9. For example, SRI 914 may be implemented as an Xn interface and/or an NG interface. In particular, each of NTN payload 906 and NTN gateway 908 implement a protocol stack for the SRI with an NG-U or Xn-U layer (similar to the NGAP layer of protocol stack 612 of FIG. 6), an SCTP layer (similar to the SCTP layer of protocol stack 612 of FIG. 6), and an IP layer (similar to the IP layer of protocol stack 612 of FIG. 6). In certain aspects, to setup the interface (e.g., NG interface) between the NTN gateway 908 and the NTN payload 906, the NTN payload 906 sends a setup request message (e.g., NG setup request message) to the NTN gateway 908 to establish the interface. In certain aspects, after receiving the setup request message, the NTN gateway 908 sends a setup response message (e.g., NG setup response message) to the NTN payload 906, wherein the setup response message includes an identifier of the NTN payload 906.

In certain aspects, with control plane protocol architecture 700 of FIG. 7 and user plane protocol architecture 900 of FIG. 9, the NTN gateway acts as a proxy core network for the NTN payload. For example, the NTN gateway terminates one or more of an Xn (e.g., Xn control plane (Xn-C) or Xn user plane (Xn-U)) or NG (e.g., NGAP or NG user plane (NG-U)) interface with the core network, such that the interface does not extend to the NTN payload from the core network. As another example, the feeder link between the NTN gateway and the NTN payload uses SRI as a transport mechanism to carry one or more of NG-AP, NG-U, Xn-AP, and/or Xn-U interface communications.

In certain aspects, with control plane protocol architecture 700 of FIG. 7 and user plane protocol architecture 900 of FIG. 9, the NTN gateway acts as a proxy RAN endpoint for the core network. For example, the NTN gateway terminates one or more of an Xn or NG interface with the RAN (e.g., NTN payload 706), such that the interface does not extend to the core network from the NTN payload.

In certain aspects, with control plane protocol architecture 700 of FIG. 7 and user plane protocol architecture 900 of FIG. 9, the NTN gateway perform Xn-AP and Xn-U routing between different NTN payloads, including the ability to store and forward user plane data, control plane signaling, and/or UE context information between NTN payloads.

### Aspects Related to UE Mobility

Certain aspects herein further provide techniques for mobility of a UE between a first NTN payload in communication with an NTN gateway and a second NTN payload in communication with the same NTN gateway. For example, certain aspects provide techniques for a UE to handover from connection to the first NTN payload to connecting to the second NTN payload. As another example, certain aspects provide techniques for a UE to re-establish a connection (e.g., RRC connection) with the second NTN payload after an RLF with the first NTN payload.

In particular, certain aspects provide an NTN gateway configured to process a path switch request received at the NTN gateway from the second NTN payload, such as without involving the core network (e.g., the AMF), or such as without changing a path (e.g., downlink path) between the NTN gateway and the AMF. A path switch request procedure is meant to establish a UE associated signaling connection (e.g., over a Uu interface and NG interface) to the core network, and if applicable, request the switch of the downlink termination point (e.g., radio access network (RAN) side termination) of the NG interface toward a new termination point. In particular, as the NG interface is between the core network and the NTN gateway, where the NTN gateway is the downlink termination point (e.g., RAN side termination point), the NG interface does not need to be re-established when the UE switches from the first NTN payload to the second NTN payload as the NG interface termination point has not changed. Rather, the NTN gateway changes the connection path for the UE from the first NTN payload to the second NTN payload, without changing the connection path between the NTN gateway and the core network. Accordingly, the UE mobility is transparent to the NG interface, and rather the NTN payload switch is used for the Uu interface.

In certain aspects, mobility messages (e.g., inter-NTN payload RRC messages for handover, such as a handover preparation information message, handover command message, etc.) are carried over an SRI interface between NTN payloads and/or NTN gateways, such as transparently and without involving core network entities. For example, a source NTN payload and target NTN payload may communicate directly with each other over an SRI interface between the source NTN payload and target NTN payload. In another example, a source NTN payload may communicate with an NTN gateway over an SRI interface between the source NTN payload and the NTN gateway, and the NTN gateway may communicate with a target NTN payload over an SRI interface between the NTN gateway and the source NTN payload, such that the source NTN payload and target NTN payload communicate via the NTN gateway. For example, the NTN gateway may be configured to forward (e.g., transparently) messages from the source NTN payload to the target NTN payload.

In certain aspects, when a UE moves connection from a source NTN payload to a target NTN payload, the security context of the UE (e.g., next hop chaining counter (NCC), next hop count, etc.) is not changed. For example, changing the security context may involve informing the core network, so not changing the security context may have the advantageous technical effect of reducing signaling with the core network, thereby reducing network congestion.

In certain aspects, where there is a handover of the UE from a source NTN payload to a target NTN payload, a master key used for securing communications with the UE is not changed (e.g., a master key update is not included in a handover command). For example, changing the master key may involve informing the core network, so not changing the master key may have the advantageous technical effect of reducing signaling with the core network, thereby reducing network congestion. In certain aspects, the source NTN payload forwards a current master key for the UE to the target NTN payload as part of the handover, such as directly via SRI, or via the NTN gateway.

Certain aspects are discussed with respect to UE handover or re-establishment between NTN payloads connected to the same NTN gateway, referred to as intra gateway handover or re-establishment. However, the techniques are also applicable to with respect to UE handover or re-establishment between NTN payloads connected to different NTN gateways, referred to as inter gateway handover or re-establishment. In particular, in certain aspects, a core network may still not be involved, and the two NTN gateways involved may directly communicate with one another, such as over an SRI. For example, the NTN gateways may exchange a path switch request, a path switch request acknowledge, and/or user data.

### Aspects Related to Handover

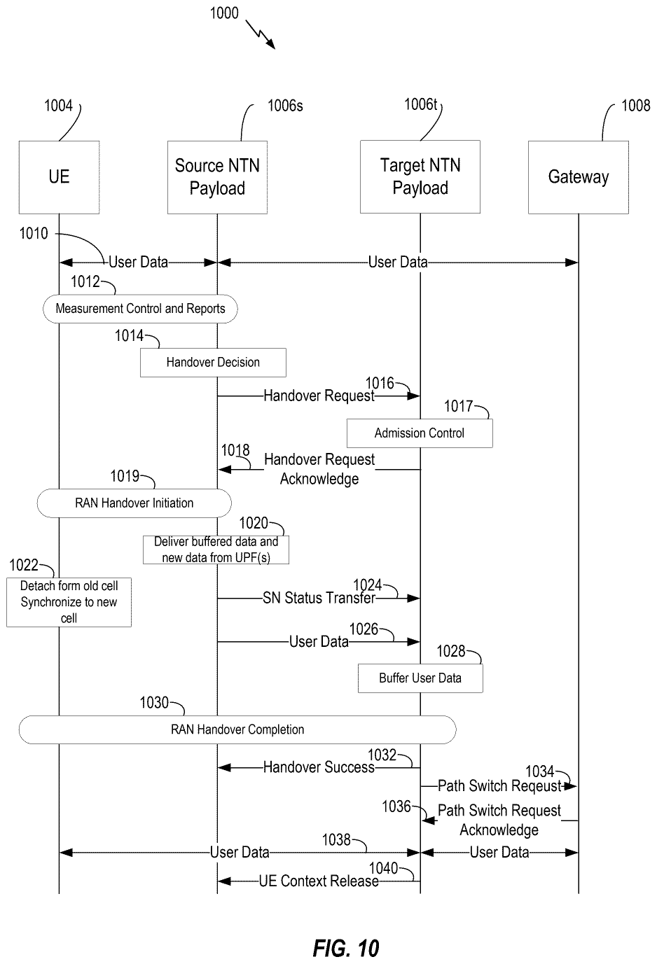

FIG. 10 illustrates a call flow 1000 for a handover of a UE from a source NTN payload to a target NTN payload. Call flow 1000 is between a UE 1004 (e.g., UE 104 of FIG. 1, any of UEs 604-904 of FIGS. 6-9, etc.), a source NTN payload 1006s (e.g., any of NTN payloads 506-906 of FIGS. 5-9, etc.), a target NTN payload 1006t (e.g., any of NTN payloads 506-906 of FIGS. 5-9, etc.), and an NTN gateway 1008 (e.g., any of NTN gateways 508-908 of FIGS. 5-9, etc.).

At 1010, UE 1004 is connected (e.g., RRC connected) to source NTN payload 1006s and communicates user data with source NTN payload 1006s, which further communicates the user data with NTN gateway 1008. Source NTN payload 1006s may store UE context information regarding UE 1004, such as information regarding roaming and access restrictions for UE 1004. At 1012, source NTN payload 1006s configures UE 1004 with UE measurement procedures to measure a signal (e.g., signal to interference plus noise ratio (SINR)) between the source NTN payload 1006s and UE 1004 and/or target NTN payload 1006t and UE 1004, and the UE 1004 reports the measurements of the signals to the source NTN payload 1006s.

At 1014, based on the report from UE 1004, source NTN payload 1006s makes a decision of whether to handover UE 1004 to target NTN payload 1006t. For the purposes of call flow 1000, it is assumed source NTN payload 1006s determines to handover UE 1004 to target NTN payload 1006t.

At 1016, source NTN payload 1006s sends a handover request to target NTN payload 1006t, requesting the handover of UE 1004 to target NTN payload 1006t. Though shown as a direct communication between source NTN payload 1006s and target NTN payload 1006t, alternatively the communication may be via NTN gateway 1008.

At 1017, target NTN payload 1006t performs admission control for UE 1004, such as slice-aware admission control based on slice information regarding UE 1004 included in the handover request. For the purposes of call flow 1000, it is assumed target NTN payload 1006t determines UE 1004 passes admission control.

At 1018, target NTN payload 1006t sends a handover request acknowledge to the source NTN payload 1006s, acknowledging that UE 1004 can handover to target NTN payload 1006t. Though shown as a direct communication between source NTN payload 1006s and target NTN payload 1006t, alternatively the communication may be via NTN gateway 1008.

At 1019, the source NTN payload 1006s triggers handover of UE 1004 (e.g., handover of the Uu connection with UE 1004) to target NTN payload 1006t, such as by sending an RRC reconfiguration message to UE 1004 containing information required for UE 1004 to access target NTN payload 1006t (e.g., target cell ID of target NTN payload 1006t, etc.). At 1020, the source NTN payload 1006s sends any buffered data and/or new data it has from the core network (e.g., a UPF) to UE 1004.

At 1022, UE 1004 detaches from source NTN payload 1006s and synchronizes with target NTN payload 1006t, such as by performing a random access procedure and/or RRC connection procedure with target NTN payload 1006t.

At 1024, source NTN payload 1006s sends a sequence number (SN) status transfer message to target NTN payload 1006t. The SN status transfer message may include a PDCP SN of UE 1004 indicating a sequence number of a current PDCP service data unit (SDU). Though shown as a direct communication between source NTN payload 1006s and target NTN payload 1006t, alternatively the communication may be via NTN gateway 1008. The SN status transfer message may be a proprietary message, such as over SRI.

At 1026, source NTN payload 1006s sends user data of UE 1004 to target NTN payload 1006t. Though shown as a direct communication between source NTN payload 1006s and target NTN payload 1006t, alternatively the communication may be via NTN gateway 1008. For example, source NTN payload 1006s may send user data to NTN gateway 1008, which may buffer the user data and later forward the buffered user data to target NTN payload 1006t, such as after receiving a path switch request message from target NTN payload 1006t.

At 1028, in certain aspects where user data is sent directly from source NTN payload 1006s to target NTN payload 1006t, target NTN payload 1006t buffers the user data received at 1026.

At 1030, UE 1004 synchronizes to target NTN payload 1006t and completes the RRC handover procedure by sending an RRC reconfiguration complete message to target NTN payload 1006t.

At 1032, target NTN payload 1006t sends a handover success message to source NTN payload 1006s to inform source NTN payload 1006s that the UE 1004 has successfully accessed target NTN payload 1006t. Though shown as a direct communication between source NTN payload 1006s and target NTN payload 1006t, alternatively the communication may be via NTN gateway 1008.

At 1034, target NTN payload 1006t sends a path switch request message to NTN gateway 1008. In certain aspects, NTN gateway 1008 processes the path switch request message at NTN gateway 1008 itself, and does not forward the path switch request message to the core network (e.g., to the AMF), as discussed. The request message may be proprietary between the target NTN payload 1006t and NTN gateway 1008, such as over SRI. In certain aspects, NTN gateway 1008 does forward the path switch request message to the core network (e.g., to the AMF), such as for changing security keys, but the path switch request message does not indicate a change in the downlink path between the NTN gateway 1008 and the core network. In particular, the downlink path between the NTN gateway 1008 and AMF may remain the same.

At 1036, NTN gateway 1008 sends a path switch request acknowledge message to target NTN payload 1006t, acknowledging the path switch is completed of the UE 1004 from source NTN payload 1006s to target NTN payload 1006t. In certain aspects, NTN gateway 1008 generates the path switch request acknowledge message at NTN gateway 1008 itself, and does not forward a path switch request acknowledge message from the core network (e.g., to the AMF), as discussed. The acknowledge message may be proprietary between the target NTN payload 1006t and NTN gateway 1008, such as over SRI.

At 1038, UE 1004 is connected (e.g., RRC connected) to target NTN payload 1006t and communicates user data with target NTN payload 1006t, which further communicates the user data with NTN gateway 1008.

At 1040, target NTN payload 1006t sends a UE context release for UE 1004 to source NTN payload 1006s, to inform source NTN payload 1006s of the successful handover of UE 1004. Source NTN payload 1006s may release radio and control plane related resources associated with the UE context of UE 1004. Though shown as a direct communication between source NTN payload 1006s and target NTN payload 1006t, alternatively the communication may be via NTN gateway 1008. The context release communication may be over SRI.

### Aspects Related to Connection Re-Establishment

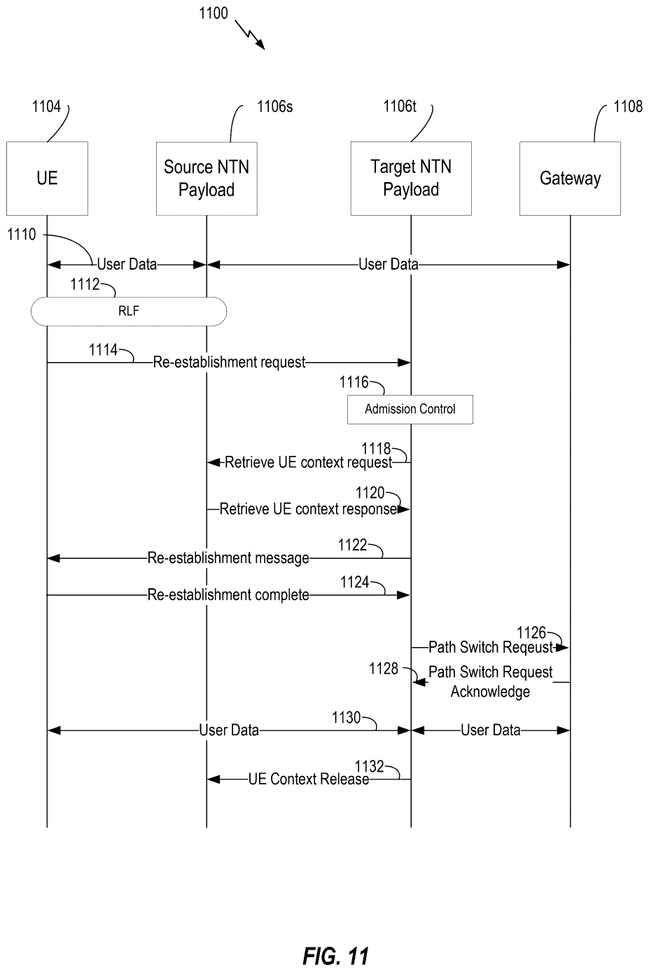

FIG. 11 illustrates a call flow 1100 for a connection re-establishment of a UE from a source NTN payload to a target NTN payload. Call flow 1100 is between a UE 1104 (e.g., UE 104 of FIG. 1, any of UEs 604-904 of FIGS. 6-9, etc.), a source NTN payload 1106s (e.g., any of NTN payloads 506-906 of FIGS. 5-9, etc.), a target NTN payload 1106t (e.g., any of NTN payloads 506-906 of FIGS. 5-9, etc.), and an NTN gateway 1108 (e.g., any of NTN gateways 508-908 of FIGS. 5-9, etc.).

At 1110, UE 1104 is connected (e.g., RRC connected) to source NTN payload 1106s and communicates user data with source NTN payload 1106s, which further communicates the user data with NTN gateway 1108. Source NTN payload 1106s may store UE context information regarding UE 1104, such as information regarding roaming and access restrictions for UE 1104.

At 1112, UE 1104 experience RLF with source NTN payload 1106s, such as due to poor signal quality between UE 1104 and source NTN payload 1106s.

At 1114, UE 1104 sends a re-establishment request (e.g., RRC re-establishment request) to target NTN payload 1106t, requesting that UE 1104 re-establish a connection with the core network via target NTN payload 1106t.

At 1116, target NTN payload 1106t performs admission control for UE 1104, such as slice-aware admission control based on slice information regarding UE 1104 included in the re-establishment request. For the purposes of call flow 1100, it is assumed target NTN payload 1106t determines UE 1104 passes admission control.

At 1118, target NTN payload 1106t requests UE context information regarding UE 1104 from source NTN payload 1106s. The request may be made over SRI. Though shown as a direct communication between source NTN payload 1106s and target NTN payload 1106t, alternatively the communication may be via NTN gateway 1108.

At 1120, source NTN payload 1106s sends the requested UE context information regarding UE 1104 to target NTN payload 1106t. The response may be made over SRI. Though shown as a direct communication between source NTN payload 1106s and target NTN payload 1106t, alternatively the communication may be via NTN gateway 1108.

At 1122, target NTN payload 1106t sends a re-establishment message (e.g., RRC reestablishment message) to UE 1104 to acknowledge the re-establishment request and information UE 1104 that it can connect to target NTN payload 1106t.

At 1124, UE 1104 re-establishes the connection (e.g., RRC connection) with target NTN payload 1106t and sends a re-establishment complete message (e.g., RRC reestablishment complete message) to target NTN payload 1106t.

At 1126, target NTN payload 1106t sends a path switch request message to NTN gateway 1108. In certain aspects, NTN gateway 1108 processes the path switch request message at NTN gateway 1108 itself, and does not forward the path switch request message to the core network (e.g., to the AMF), as discussed. The request message may be proprietary between the target NTN payload 1106t and NTN gateway 1108, such as over SRI. In certain aspects, NTN gateway 1108 does forward the path switch request message to the core network (e.g., to the AMF), such as for changing security keys, but the path switch request message does not indicate a change in the downlink path between the NTN gateway 1108 and the core network. In particular, the downlink path between the NTN gateway 1108 and AMF may remain the same.

At 1128, NTN gateway 1108 sends a path switch request acknowledge message to target NTN payload 1106t, acknowledging the path switch is completed of the UE 1104 from source NTN payload 1106s to target NTN payload 1106t. In certain aspects, NTN gateway 1108 generates the path switch request acknowledge message at NTN gateway 1108 itself, and does not forward a path switch request acknowledge message from the core network (e.g., to the AMF), as discussed. The acknowledge message may be proprietary between the target NTN payload 1106t and NTN gateway 1108, such as over SRI.

At 1130, UE 1104 is connected (e.g., RRC connected) to target NTN payload 1106t and communicates user data with target NTN payload 1106t, which further communicates the user data with NTN gateway 1108.

At 1132, target NTN payload 1106t sends a UE context release for UE 1104 to source NTN payload 1106s, to inform source NTN payload 1106s of the successful connection of UE 1104. Source NTN payload 1106s may release radio and control plane related resources associated with the UE context of UE 1104. Though shown as a direct communication between source NTN payload 1106s and target NTN payload 1106t, alternatively the communication may be via NTN gateway 1108. The context release may be made over SRI.

### Aspects Related to Store and Forward

Certain aspects herein provide an NTN payload configured to store UE data (e.g., control plane data, user plane data, UE context information, etc.). For example, referring back to FIG. 5, UE 504 may send data to NTN payload 506 for communication to 5GC 590. In certain cases, the feeder link between NTN payload 506 and NTN gateway 508 is not available, such as due to movement of the NTN payload 506 with respect to NTN gateway 508. Accordingly, NTN payload 506 may store/buffer the data until a feeder link is available between NTN payload 506 and NTN gateway 508, and send the data to NTN gateway 508 when the feeder link is available. In certain aspects, the NTN payload 506 stores an identifier of the UE associated with the UE data or other information to identify the UE along with the UE data. Accordingly, the NTN payload 506 can indicate to which UE the UE data belongs. In certain aspects, NTN gateway 508 may similarly store/buffer UE data (along with information to identify the UE) until a feeder link is available between NTN payload 506 and NTN gateway 508, such as to send UE data to the NTN payload 506.

Certain aspects herein provide for configuring a UE, such as UE 504, with an indication of a delay (e.g., expected or estimated delay) in communication between an NTN payload, such as NTN payload 506, and an NTN gateway, such as NTN gateway 508. As discussed, the interface used for communication between the NTN payload 506 and the NTN gateway 508 may be referred to as an SRI. Accordingly, the delay in communication between NTN payload 506 and NTN gateway 508 may be referred to as an SRI delay. The SRI delay may be configured based on the time that a message takes to be communicated between the NTN gateway 508 and NTN payload 506. The time that a message takes to be communicated between NTN gateway 508 and NTN payload 506 may be based on a distance between NTN gateway 508 and NTN payload 506, and may be calculated using a formula that takes distance as input and output time for a message to be communicated. In another example, the time that a message takes to be communicated between the NTN gateway 508 and NTN payload 506 may be measured based on exchange of a request and response message measuring round trip time between NTN gateway 508 and NTN payload 506. The SRI delay may also be configured based on an estimated time for feeder link unavailability (referred to as a feeder link discontinuous gap length) between NTN gateway 508 and NTN payload 506, which may be determined based on a flight path of the NTN payload 506 with respect to NTN gateway 508, may actually be measured during movement of the NTN payload 506 with respect to NTN gateway 508, etc. For example, SRI delay may be calculated as the sum of a feeder link discontinuous gap length and a time that a message takes to be communicated between the NTN gateway 508 and NTN payload 506.

The NTN payload 506 may configure the UE 504 with an indication of the SRI delay such as by sending the indication in signaling, such as via broadcast or such as UE specific signaling (e.g., an RRC message or a non-access stratum (NAS) message, such as an attach accept message). The SRI delay may be determined and/or updated by the 5GC 590, and signaled from the 5GC 590 to UE 504 via the NTN payload 506.

In certain aspects, the UE 504, NTN payload 506, NTN gateway 508, and/or 5GC 590 are configured to use the SRI delay to set one or more timers to buffer/wait for sending/receiving messages, such as response or request messages. For example, the UE 504 may send a request message (e.g., attach request, RRC setup request, RRC resume request, RRC reestablishment request, registration request, etc.) and have a timer or buffer running that indicates a time period UE 504 waits for a response message (e.g., attach response, RRC setup response, RRC resume response, RRC reestablishment response, registration response, etc.) to the request message before determining the request message is unsuccessful (e.g., and retrying sending the request message). The length of the timer or buffer accordingly may be set based on the SRI delay, such as equal to the SRI delay plus some additional delay. Accordingly, UE 504 does not timeout on waiting for a response message when a response message may be delayed based on SRI delay, which reduces retrying sending the request message.

Further, in certain aspects, where a first NTN payload is storing UE data due to a feeder link being unavailable, and the UE establishes a connection with a second NTN payload, such as due to re-establishment because connectivity with the first NTN payload is lost, the first NTN payload may forward the UE data to the NTN gateway when a feeder link is available, such that the NTN gateway can forward the data to the second NTN payload. One technical effect and advantage of configuring the first NTN payload to forward UE data via the NTN gateway to the second NTN payload is that even if the UE re-establishes connection with the second NTN payload while the first NTN payload does not have a feeder link, the UE data is still communicated to the second NTN payload and is not dropped.

### Example Operations

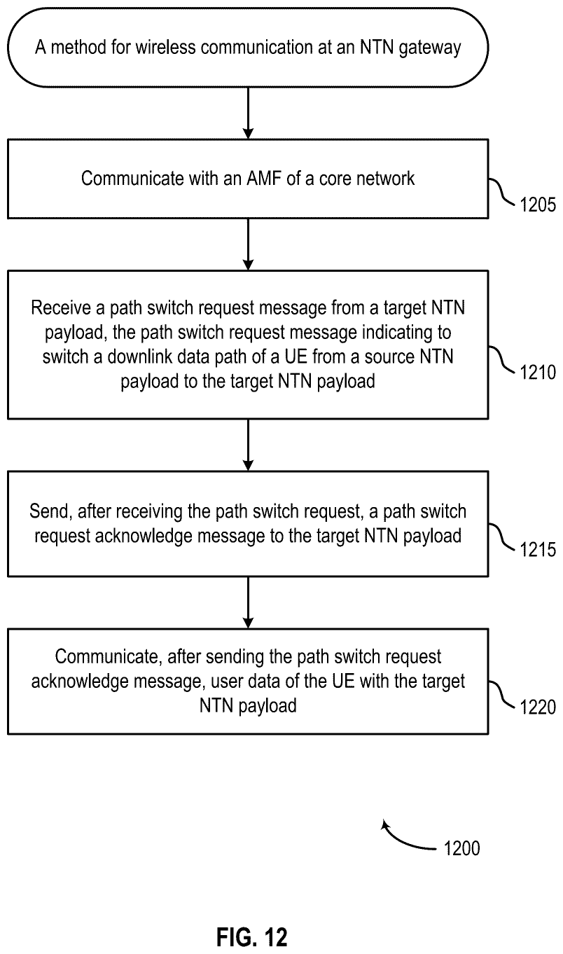

FIG. 12 shows a method 1200 for wireless communication at an NTN gateway, such as any of NTN gateways 508-1108 of FIGS. 5-11.

Method 1200 begins at step 1205 with communicating with an AMF of a core network.

Method 1200 then proceeds to step 1210 with receiving a path switch request message from a target NTN payload, the path switch request message indicating to switch a downlink data path of a UE from a source NTN payload to the target NTN payload.

Method 1200 then proceeds to step 1215 with sending, after receiving the path switch request message, a path switch request acknowledge message to the target NTN payload.

Method 1200 then proceeds to step 1220 with communicating, after sending the path switch request acknowledge message, user data of the UE with the target NTN payload.

A technical effect and advantage of method 1200 is that for a handover or re-establishment procedure, the path switch request is handled by the NTN gateway without involving the core network (e.g., AMF). Therefore, there is reduced signaling with the core network, and reduced overhead at the core network.

In one aspect, the path switch request message is not sent by the NTN gateway to the AMF.

In one aspect, step 1205 further includes communicating with the AMF over a first interface that is a point-to-point interface between the NTN gateway and the AMF. A technical effect and advantage is that the interface terminates at the NTN gateway instead of at the NTN payload, such that data is processed at the NTN gateway, instead of creating overhead for processing of data at the NTN payload.

In one aspect, the first interface is an NG interface.

In one aspect, method 1200 further includes sending a setup request message to the AMF to establish the first interface.

In one aspect, method 1200 further includes, after sending the setup request message, receiving a setup response message from the AMF, wherein the setup response message includes an identifier of the NTN gateway. In certain aspects, including the identifier of the NTN gateway ensures the interface is between the AMF and the NTN gateway.

In one aspect, method 1200 further includes receiving a second setup request message from the target NTN payload to establish a second interface, wherein the second interface is a point-to-point interface between the NTN gateway and the target NTN payload.

In one aspect, method 1200 further includes, after receiving the second setup request message, sending a second setup response message to the target NTN payload, wherein the second setup response message includes an identifier of the target NTN payload. In certain aspects, including the identifier of the NTN payload ensures the interface is between the NTN payload and the NTN gateway.

In one aspect, step 1220 further includes communicating with the target NTN payload over an NG interface or an Xn interface, wherein the NG interface or Xn interface is a point-to-point interface between the NTN gateway and the target NTN payload. A technical effect and advantage of using existing communication interfaces of 3GPP is to reduce processor complexity needed to communicate between the NTN payload and NTN gateway.

In one aspect, the NTN gateway is configured to not process RRC messages and to not process a PDCP layer of packets. A technical effect and advantage is that there is reduced need for sending messages for RRC and PDCP processing to the NTN gateway from the NTN payload.

In one aspect, method 1200 further includes receiving a RRC message from the source NTN payload.

In one aspect, method 1200 further includes forwarding the RRC message to the target NTN payload without processing the RRC message. A technical effect and advantage is to reduce processing at the NTN gateway.

In one aspect, method 1200 further includes storing UE context information for the UE.

In one aspect, method 1200 further includes sending the UE context information to the target NTN payload. A technical effect and advantage is that the target NTN payload can receive UE context information from the NTN gateway when the feeder link is available, and even if a direct link between source and target NTN payloads is not available thereby increasing reliability of receiving UE context information.

In one aspect, method 1200 further includes receiving the UE context information from the source NTN payload.

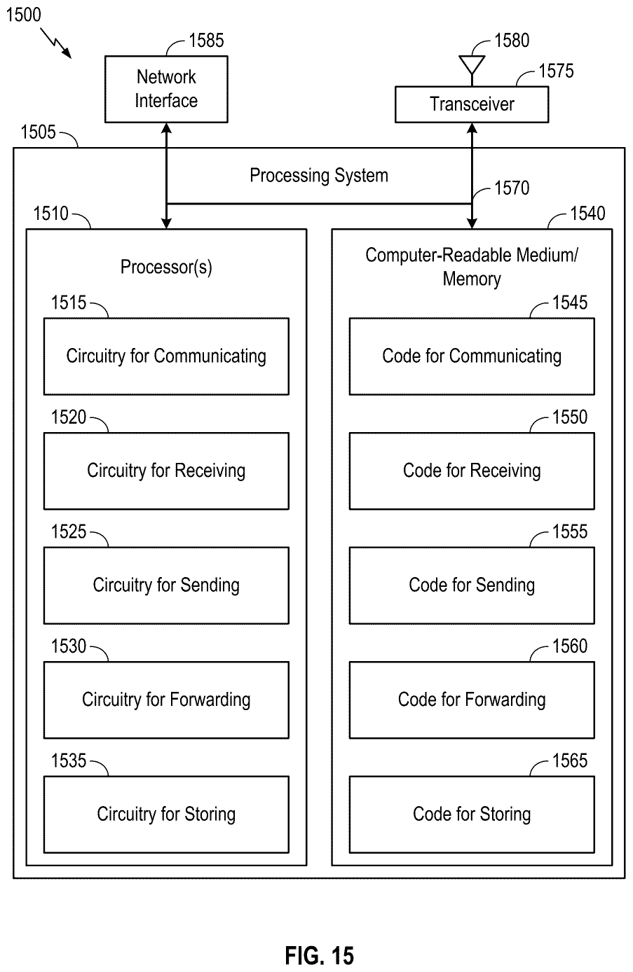

In one aspect, method 1200, or any aspect related to it, may be performed by an apparatus, such as communications device 1500 of FIG. 15, which includes various components operable, configured, or adapted to perform the method 1200. Communications device 1500 is described below in further detail.

Note that FIG. 12 is just one example of a method, and other methods including fewer, additional, or alternative steps are possible consistent with this disclosure.

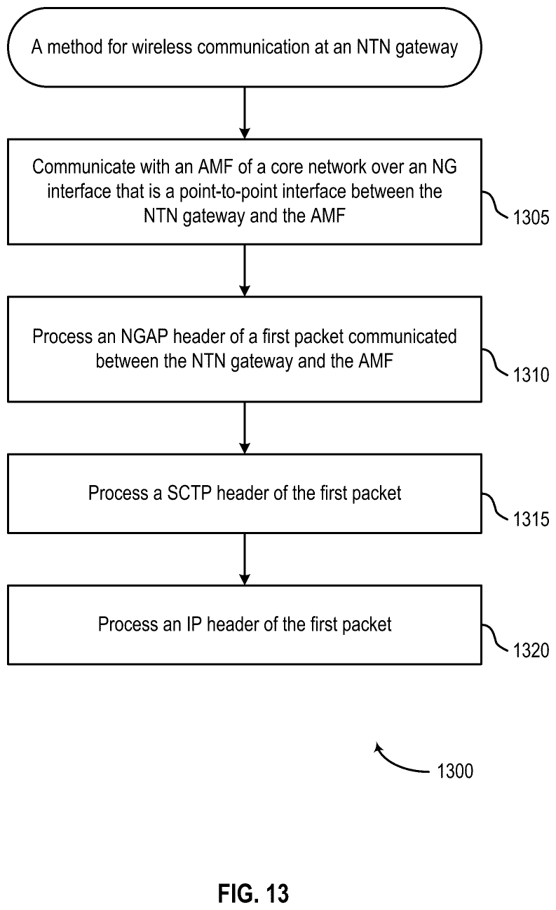

FIG. 13 shows a method 1300 for wireless communication at an NTN gateway, such as any of NTN gateways 508-1108 of FIGS. 5-11.

Method 1300 begins at step 1305 with communicating with an AMF of a core network over an NG interface that is a point-to-point interface between the NTN gateway and the AMF.

Method 1300 then proceeds to step 1310 with processing an NGAP header of a first packet communicated between the NTN gateway and the AMF.

Method 1300 then proceeds to step 1315 with processing a SCTP header of the first packet.

Method 1300 then proceeds to step 1320 with processing an IP header of the first packet.

In one aspect, method 1300 further includes processing a GTP-U header of a third packet communicated between the NTN gateway and a UPF of the core network.

In one aspect, method 1300 further includes processing a UDP header of the third packet.

In one aspect, method 1300 further includes processing an IP header of the third packet.

In one aspect, method 1300 further includes processing an NGAP or Xn header of a third packet communicated between the NTN gateway and the NTN payload. A technical effect and advantage of using existing communication interfaces of 3GPP is to reduce processor complexity needed to communicate between the NTN payload and NTN gateway.

In one aspect, method 1300 further includes processing an SCTP header of the third packet.

In one aspect, method 1300 further includes processing an IP header of the third packet.

In one aspect, method 1300 further includes processing an NGAP or Xn header of a third packet communicated between the NTN gateway and the NTN payload. A technical effect and advantage of using existing communication interfaces of 3GPP is to reduce processor complexity needed to communicate between the NTN payload and NTN gateway.

In one aspect, method 1300 further includes processing a UDP header of the third packet.

In one aspect, method 1300 further includes processing an IP header of the third packet.

In one aspect, method 1300 further includes receiving information comprising user plane data, control plane signaling, or UE context information of the UE from the NTN payload.

In one aspect, method 1300 further includes sending the information to a second NTN payload. A technical effect and advantage is that the target NTN payload can receive data from the NTN gateway when the feeder link is available, and even if a direct link between source and target NTN payloads is not available thereby increasing reliability of receiving data.

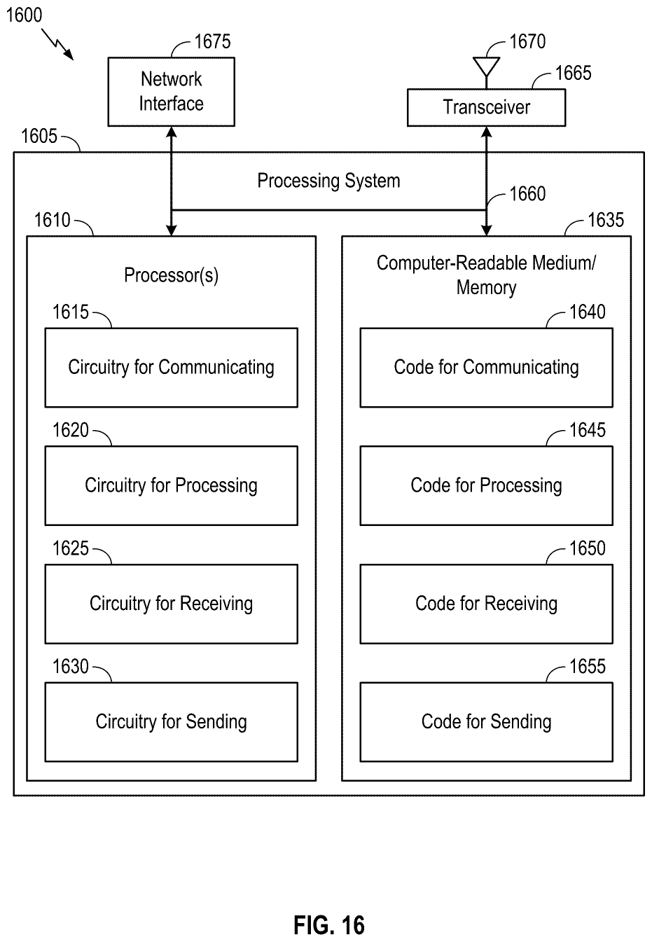

In one aspect, method 1300, or any aspect related to it, may be performed by an apparatus, such as communications device 1600 of FIG. 16, which includes various components operable, configured, or adapted to perform the method 1300. Communications device 1600 is described below in further detail.

Note that FIG. 13 is just one example of a method, and other methods including fewer, additional, or alternative steps are possible consistent with this disclosure.

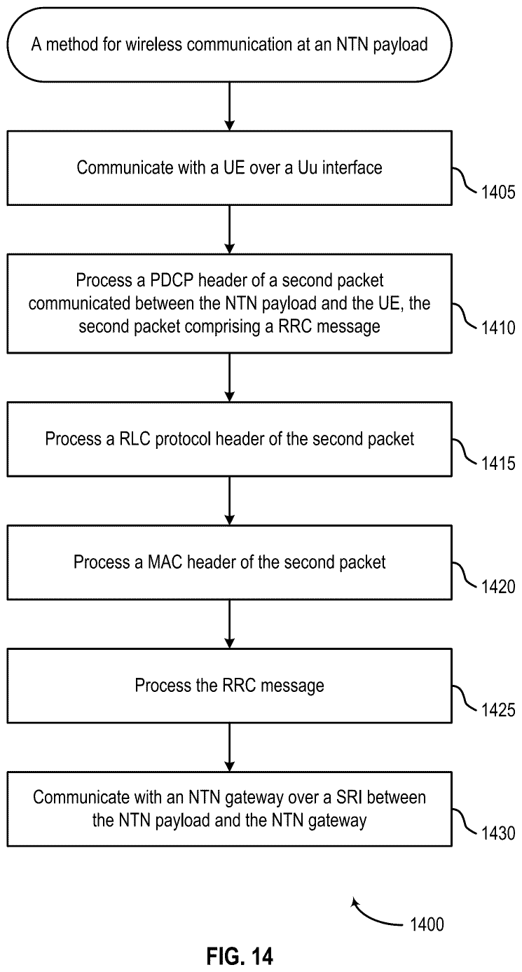

FIG. 14 shows a method 1400 for wireless communication at an NTN payload, such as any of NTN payloads 506-1106 of FIGS. 5-11.

Method 1400 begins at step 1405 with communicating with a UE over a Uu interface.

Method 1400 then proceeds to step 1410 with processing a PDCP header of a second packet communicated between the NTN payload and the UE, the second packet comprising a RRC message.

Method 1400 then proceeds to step 1415 with processing a RLC protocol header of the second packet.

Method 1400 then proceeds to step 1420 with processing a MAC header of the second packet.

Method 1400 then proceeds to step 1425 with processing the RRC message.

Method 1400 then proceeds to step 1430 with communicating with an NTN gateway over a SRI between the NTN payload and the NTN gateway.

In one aspect, method 1400 further includes processing a SDAP header of a fourth packet communicated between the NTN payload and the UE.

In one aspect, method 1400 further includes processing a PDCP header of the fourth packet.

In one aspect, method 1400 further includes processing an RLC protocol header of the fourth packet.

In one aspect, method 1400 further includes processing a MAC header of the fourth packet.

In one aspect, method 1400 further includes storing data of the UE at a first time when a link between the NTN payload and the NTN gateway is unavailable.

In one aspect, method 1400 further includes sending the data to the NTN gateway at a second time when the link between the NTN payload and the NTN gateway is available. A technical effect and advantage is that the target NTN payload can communicate with the UE even when a feeder link with the NTN gateway is not available, and then forward data when the feeder link is available, thereby reducing communication delay with the UE.

In one aspect, method 1400 further includes sending to the UE an indication of communication delay between the NTN gateway and the NTN payload on the SRI. A technical effect and advantage is that there is a reduced change of time out at the UE based on communication delay between the NTN payload and the NTN gateway as timers are set internally in the UE to account for the delay.

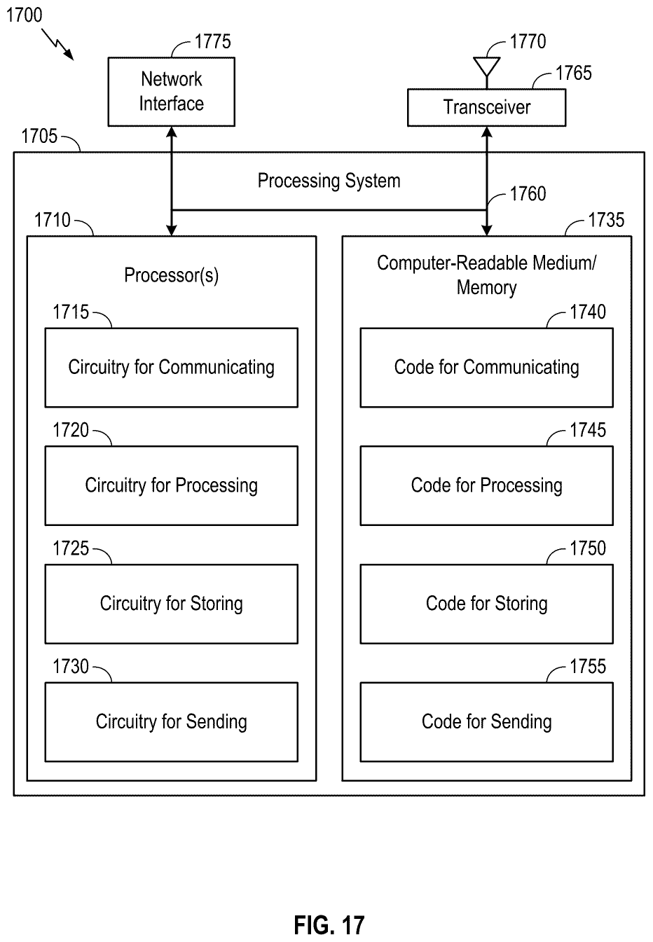

In one aspect, method 1400, or any aspect related to it, may be performed by an apparatus, such as communications device 1700 of FIG. 17, which includes various components operable, configured, or adapted to perform the method 1400. Communications device 1700 is described below in further detail.

Note that FIG. 14 is just one example of a method, and other methods including fewer, additional, or alternative steps are possible consistent with this disclosure.

### Example Communications Devices

FIG. 15 depicts aspects of an example communications device. In some aspects, communications device 1500 is an NTN gateway or network entity, such as any of NTN gateways 508-1108 of FIGS. 5-11.

The communications device 1500 includes a processing system 1505 coupled to a transceiver 1575 (e.g., a transmitter and/or a receiver) and/or a network interface 1585. The transceiver 1575 is configured to transmit and receive signals for the communications device 1500 via an antenna 1580, such as the various signals as described herein. The network interface 1585 is configured to obtain and send signals for the communications device 1500 via communications link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510. In various aspects, one or more processors 1510 may be representative of one or more of receive processor 338, transmit processor 320, TX MIMO processor 330, and/or controller/processor 340, as described with respect to FIG. 3. The one or more processors 1510 are coupled to a computer-readable medium/memory 1540 via a bus 1570. In certain aspects, the computer-readable medium/memory 1540 is configured to store instructions (e.g., computer-executable code), including code for communicating 1545, code for receiving 1550, code for sending 1555, code for forwarding 1560, and code for storing 1565, that when executed by the one or more processors 1510, enable and cause the one or more processors 1510 to perform the method 1200 described with respect to FIG. 12, or any aspect related to it, including any additional steps or sub-steps described in relation to FIG. 12. Note that reference to a processor of communications device 1500 performing a function may include one or more processors of communications device 1500 performing that function. For example, one processor may perform the function, or multiple processors may perform the functions in a distributed fashion.

In the depicted example, the computer-readable medium/memory 1540 stores code 1545-1565. Processing of the code 1545-1565 may enable and cause the communications device 1500 to perform the method 1200 described with respect to FIG. 12, or any aspect related to it.

The one or more processors 1510 include circuitry configured to implement (e.g., execute) the code stored in the computer-readable medium/memory 1540, including circuitry for communicating 1515, circuitry for receiving 1520, circuitry for sending 1525, circuitry for forwarding 1530, and circuitry for storing 1535. Processing with circuitry 1515-1535 may enable and cause the communications device 1500 to perform the method 1200 described with respect to FIG. 12, or any aspect related to it.

More generally, means for communicating, transmitting, sending or outputting for transmission may include the transceivers 332, antenna(s) 334, transmit processor 320, TX MIMO processor 330, and/or controller/processor 340 of the BS 102 illustrated in FIG. 3, transceiver 1575 and/or antenna 1580 of the communications device 1500 in FIG. 15, and/or one or more processors 1510 of the communications device 1500 in FIG. 15. Means for communicating, receiving or obtaining may include the transceivers 332, antenna(s) 334, receive processor 338, and/or controller/processor 340 of the BS 102 illustrated in FIG. 3, transceiver 1575 and/or antenna 1580 of the communications device 1500 in FIG. 15, and/or one or more processors 1510 of the communications device 1500 in FIG. 15.

FIG. 16 depicts aspects of an example communications device. In some aspects, communications device 1600 is a NTN gateway or network entity, such as any of NTN gateways 508-1108 of FIGS. 5-11.

The communications device 1600 includes a processing system 1605 coupled to a transceiver 1665 (e.g., a transmitter and/or a receiver) and/or a network interface 1675. The transceiver 1665 is configured to transmit and receive signals for the communications device 1600 via an antenna 1670, such as the various signals as described herein. The network interface 1675 is configured to obtain and send signals for the communications device 1600 via communications link(s), such as a backhaul link, midhaul link, and/or fronthaul link as described herein, such as with respect to FIG. 2. The processing system 1605 may be configured to perform processing functions for the communications device 1600, including processing signals received and/or to be transmitted by the communications device 1600.

The processing system 1605 includes one or more processors 1610. In various aspects, one or more processors 1610 may be representative of one or more of receive processor 338, transmit processor 320, TX MIMO processor 330, and/or controller/processor 340, as described with respect to FIG. 3. The one or more processors 1610 are coupled to a computer-readable medium/memory 1635 via a bus 1660. In certain aspects, the computer-readable medium/memory 1635 is configured to store instructions (e.g., computer-executable code), including code for communicating 1640, code for processing 1645, code for receiving 1650, and code for sending 1655, that when executed by the one or more processors 1610, enable and cause the one or more processors 1610 to perform the method 1300 described with respect to FIG. 13, or any aspect related to it, including any additional steps or sub-steps described in relation to FIG. 13. Note that reference to a processor of communications device 1600 performing a function may include one or more processors of communications device 1600 performing that function. For example, one processor may perform the function, or multiple processors may perform the function in a distributed fashion.

In the depicted example, the computer-readable medium/memory 1635 stores code 1640-1655. Processing of the code 1640-1655 may enable and cause the communications device 1600 to perform the method 1300 described with respect to FIG. 13, or any aspect related to it.

The one or more processors 1610 include circuitry configured to implement (e.g., execute) the code stored in the computer-readable medium/memory 1635, including circuitry for communicating 1615, circuitry for processing 1620, circuitry for receiving 1625, and circuitry for sending 1630. Processing with circuitry 1615-1630 may enable and cause the communications device 1600 to perform the method 1300 described with respect to FIG. 13, or any aspect related to it.

More generally, means for communicating, transmitting, sending or outputting for transmission may include the transceivers 332, antenna(s) 334, transmit processor 320, TX MIMO processor 330, and/or controller/processor 340 of the BS 102 illustrated in FIG. 3, transceiver 1665 and/or antenna 1670 of the communications device 1600 in FIG. 16, and/or one or more processors 1610 of the communications device 1600 in FIG. 16. Means for communicating, receiving or obtaining may include the transceivers 332, antenna(s) 334, receive processor 338, and/or controller/processor 340 of the BS 102 illustrated in FIG. 3, transceiver 1665 and/or antenna 1670 of the communications device 1600 in FIG. 16, and/or one or more processors 1610 of the communications device 1600 in FIG. 16.

FIG. 17 depicts aspects of an example communications device. In some aspects, communications device 1700 is a, NTN payload or network entity, such as any of NTN payloads 506-1106 of FIGS. 5-11.

The communications device 1700 includes a processing system 1705 coupled to a transceiver 1765 (e.g., a transmitter and/or a receiver) and/or a network interface 1775. The transceiver 1765 is configured to transmit and receive signals for the communications device 1700 via an antenna 1770, such as the various signals as described herein. The network interface 1775 is configured to obtain and send signals for the communications device 1700 via communications link(s), such as a backhaul link, midhaul link, and/or fronthaul link as described herein, such as with respect to FIG. 2. The processing system 1705 may be configured to perform processing functions for the communications device 1700, including processing signals received and/or to be transmitted by the communications device 1700.

The processing system 1705 includes one or more processors 1710. In various aspects, one or more processors 1710 may be representative of one or more of receive processor 338, transmit processor 320, TX MIMO processor 330, and/or controller/processor 340, as described with respect to FIG. 3. The one or more processors 1710 are coupled to a computer-readable medium/memory 1735 via a bus 1760. In certain aspects, the computer-readable medium/memory 1735 is configured to store instructions (e.g., computer-executable code), including code for communicating 1740, code for processing 1745, code for storing 1750, and code for sending 1755, that when executed by the one or more processors 1710, enable and cause the one or more processors 1710 to perform the method 1400 described with respect to FIG. 14, or any aspect related to it, including any additional steps or sub-steps described in relation to FIG. 14. Note that reference to a processor of communications device 1700 performing a function may include one or more processors of communications device 1700 performing that function. For example, one processor may perform the function, or multiple processors may perform the function in a distributed fashion.

In the depicted example, the computer-readable medium/memory 1735 stores code 1740-1755. Processing of the code 1740-1755 may enable and cause the communications device 1700 to perform the method 1400 described with respect to FIG. 14, or any aspect related to it.

The one or more processors 1710 include circuitry configured to implement (e.g., execute) the code stored in the computer-readable medium/memory 1735, including circuitry for communicating 1715, circuitry for processing 1720, circuitry for storing 1725, and circuitry for sending 1730. Processing with circuitry 1715-1730 may enable and cause the communications device 1700 to perform the method 1400 described with respect to FIG. 14, or any aspect related to it.

More generally, means for communicating, transmitting, sending or outputting for transmission may include the transceivers 332, antenna(s) 334, transmit processor 320, TX MIMO processor 330, and/or controller/processor 340 of the BS 102 illustrated in FIG. 3, transceiver 1765 and/or antenna 1770 of the communications device 1700 in FIG. 17, and/or one or more processors 1710 of the communications device 1700 in FIG. 17. Means for communicating, receiving or obtaining may include the transceivers 332, antenna(s) 334, receive processor 338, and/or controller/processor 340 of the BS 102 illustrated in FIG. 3, transceiver 1765 and/or antenna 1770 of the communications device 1700 in FIG. 17, and/or one or more processors 1710 of the communications device 1700 in FIG. 17.

### Example Clauses

Implementation examples are described in the following numbered clauses:
Clause 1: A method for wireless communications by an NTN gateway comprising: communicating with an AMF of a core network; receiving a path switch request message from a target NTN payload, the path switch request message indicating to switch a downlink data path of a UE from a source NTN payload to the target NTN payload; after receiving the path switch request message, sending a path switch request acknowledge message to the target NTN payload; and after sending the path switch request acknowledge message, communicating user data of the UE with the target NTN payload.
Clause 2: The method of Clause 1, wherein the path switch request message is not sent by the NTN gateway to the AMF.
Clause 3: The method of any one of Clauses 1 and 2, wherein, to communicate with the AMF, the NTN gateway communicates with the AMF over a first interface that is a point-to-point interface between the NTN gateway and the AMF.
Clause 4: The method of Clause 3, wherein the first interface is an NG interface.
Clause 5: The method of Clause 3, further comprising: sending a setup request message to the AMF to establish the first interface; and after sending the setup request message, receiving a setup response message from the AMF, wherein the setup response message includes an identifier of the NTN gateway.
Clause 6: The method of Clause 5, further comprising: receiving a second setup request message from the target NTN payload to establish a second interface, wherein the second interface is a point-to-point interface between the NTN gateway and the target NTN payload; and after receiving the second setup request message, sending a second setup response message to the target NTN payload, wherein the second setup response message includes an identifier of the target NTN payload.
Clause 7: The method of Clause 3, wherein, to communicate user data of the UE with the target NTN payload, the NTN gateway communicates with the target NTN payload over an NG interface or an Xn interface, wherein the NG interface or Xn interface is a point-to-point interface between the NTN gateway and the target NTN payload.
Clause 8: The method of any one of Clauses 1-7, wherein the NTN gateway is configured to not process RRC messages and to not process a PDCP layer of packets.
Clause 9: The method of any one of Clauses 1-8, further comprising: receiving a RRC message from the source NTN payload; and forwarding the RRC message to the target NTN payload without processing the RRC message.
Clause 10: The method of any one of Clauses 1-9, further comprising: storing UE context information for the UE; storing information to identify the UE; and sending the UE context information to the target NTN payload.
Clause 11: The method of Clause 10, further comprising: receiving the UE context information from the source NTN payload.
Clause 12: A method for wireless communications in an NTN comprising: by an NTN gateway: communicating with an AMF of a core network over an NG interface that is a point-to-point interface between the NTN gateway and the AMF; processing an NGAP header of a first packet communicated between the NTN gateway and the AMF; processing a SCTP header of the first packet; and processing an IP header of the first packet; and the method further comprising, by an NTN payload: communicating with a UE over a Uu interface; processing a PDCP header of a second packet communicated between the NTN payload and the UE, the second packet comprising a RRC message; processing a RLC protocol header of the second packet; processing a MAC header of the second packet; processing the RRC message; and communicating with the NTN gateway over a SRI between the NTN payload and the NTN gateway.
Clause 13: The method of Clause 12, further comprising, by the NTN gateway: processing a GTP-U header of a third packet communicated between the NTN gateway and a UPF of the core network; processing a UDP header of the third packet; and process an IP header of the third packet; and further comprising, by the NTN payload: processing a SDAP header of a fourth packet communicated between the NTN payload and the UE; processing a PDCP header of the fourth packet; processing an RLC protocol header of the fourth packet; and processing a MAC header of the fourth packet.
Clause 14: The method of any one of Clauses 12-13, further comprising, by the NTN gateway: processing an NGAP or Xn header of a third packet communicated between the NTN gateway and the NTN payload; processing an SCTP header of the third packet; and processing an IP header of the third packet.
Clause 15: The method of any one of Clauses 12-14, further comprising, by the NTN gateway: processing an NGAP or Xn header of a third packet communicated between the NTN gateway and the NTN payload; processing a UDP header of the third packet; and processing an IP header of the third packet.
Clause 16: The method of any one of Clauses 12-15, further comprising, by the NTN gateway: receiving information comprising user plane data, control plane signaling, or UE context information of the UE from the NTN payload; and sending the information to a second NTN payload.
Clause 17: The method of any one of Clauses 12-16, further comprising, by the NTN payload: storing data of the UE at a first time when a link between the NTN payload and the NTN gateway is unavailable; and sending the data to the NTN gateway at a second time when the link between the NTN payload and the NTN gateway is available.
Clause 18: The method of any one of Clauses 12-17, further comprising, by the NTN payload: sending to the UE an indication of communication delay between the NTN gateway and the NTN payload on the SRI.
Clause 19: The method of Clause 1, wherein the path switch request message is sent by the NTN gateway to the AMF, the path switch request message not indicating a change in the downlink path between the NTN gateway and the AMF.
Clause 20: One or more apparatuses, comprising: memory comprising executable instructions; and one or more processors configured to execute the executable instructions and cause the one or more apparatuses to perform a method in accordance with any one of Clauses 1-19.
Clause 21: One or more apparatuses, comprising means for performing a method in accordance with any one of Clauses 1-19.
Clause 22: One or more non-transitory computer-readable media comprising executable instructions that, when executed by one or more processors of one or more apparatuses, cause the one or more apparatuses to perform a method in accordance with any one of Clauses 1-19.
Clause 23: One or more computer program products embodied on one or more computer-readable storage media comprising code for performing a method in accordance with any one of Clauses 1-19.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A non-terrestrial network (NTN) gateway configured for wireless communications, comprising:
memory comprising processor-executable instructions; and one or more processors configured to execute the processor-executable instructions and cause the NTN gateway to:
communicate with an access and mobility management function (AMF) of a core network;
receive a path switch request message from a target NTN payload, the path switch request message indicating to switch a downlink data path of a user equipment (UE) from a source NTN payload to the target NTN payload;
after receiving the path switch request message, send a path switch request acknowledge message to the target NTN payload; and
after sending the path switch request acknowledge message, communicate user data of the UE with the target NTN payload.

2. The NTN gateway of claim 1, wherein the path switch request message is not sent by the NTN gateway to the AMF.

3. The NTN gateway of claim 1, wherein the path switch request message is sent by the NTN gateway to the AMF, the path switch request message not indicating a change in the downlink path between the NTN gateway and the AMF.

4. The NTN gateway of claim 1, wherein, to communicate with the AMF, the one or more processors are configured to execute the processor-executable instructions and cause the NTN gateway to communicate with the AMF over a first interface that is a point-to-point interface between the NTN gateway and the AMF.

5. The NTN gateway of claim 4, wherein the one or more processors are configured to execute the processor-executable instructions and further cause the NTN gateway to:
send a setup request message to the AMF to establish the first interface, wherein the first interface is an NG interface; and
after sending the setup request message, receive a setup response message from the AMF, wherein the setup response message includes an identifier of the NTN gateway.

6. The NTN gateway of claim 5, wherein the one or more processors are configured to execute the processor-executable instructions and further cause the NTN gateway to:
receive a second setup request message from the target NTN payload to establish a second interface, wherein the second interface is a point-to-point interface between the NTN gateway and the target NTN payload; and
after receiving the second setup request message, send a second setup response message to the target NTN payload, wherein the second setup response message includes an identifier of the target NTN payload.

7. The NTN gateway of claim 4, wherein, to communicate user data of the UE with the target NTN payload, the one or more processors are configured to execute the processor-executable instructions and cause the NTN gateway to communicate with the target NTN payload over an NG interface or an Xn interface, wherein the NG interface or Xn interface is a point-to-point interface between the NTN gateway and the target NTN payload.

8. The NTN gateway of claim 1, wherein the NTN gateway is configured to not process radio resource control (RRC) messages and to not process a packet data convergence protocol (PDCP) layer of packets.

9. The NTN gateway of claim 1, wherein the one or more processors are configured to execute the processor-executable instructions and further cause the NTN gateway to:
receive a radio resource control (RRC) message from the source NTN payload; and
forward the RRC message to the target NTN payload without processing the RRC message.

10. The NTN gateway of claim 1, wherein the one or more processors are configured to execute the processor-executable instructions and further cause the NTN gateway to:
store UE context information for the UE; and
store information to identify the UE; and
send the UE context information to the target NTN payload.

11. The NTN gateway of claim 10, wherein the one or more processors are configured to execute the processor-executable instructions and further cause the NTN gateway to:
receive the UE context information from the source NTN payload.

12. A non-terrestrial network (NTN) system configured for wireless communications, comprising:
an NTN gateway comprising first memory comprising first processor-executable instructions; and one or more first processors configured to execute the first processor-executable instructions and cause the NTN gateway to:
communicate with an access and mobility management function (AMF) of a core network over an NG interface that is a point-to-point interface between the NTN gateway and the AMF;
process an NG application protocol (NGAP) header of a first packet communicated between the NTN gateway and the AMF;
process a stream control transmission protocol (SCTP) header of the first packet; and
process an Internet protocol (IP) header of the first packet; and
an NTN payload comprising second memory comprising second processor-executable instructions; and one or more second processors configured to execute the second processor-executable instructions and cause the NTN payload to:
communicate with a user equipment (UE) over a Uu interface;
process a packet data convergence protocol (PDCP) header of a second packet communicated between the NTN payload and the UE, the second packet comprising a radio resource control (RRC) message;
process a radio link control (RLC) protocol header of the second packet;
process a medium access control (MAC) header of the second packet;
process the RRC message; and
communicate with the NTN gateway over a satellite radio interface (SRI) between the NTN payload and the NTN gateway.

13. The NTN system of claim 12, wherein:
the one or more first processors are configured to execute the first processor-executable instructions and further cause the NTN gateway to:
process a general packet radio system (GPRS) tunneling protocol user plane (GTP-U) header of a third packet communicated between the NTN gateway and a user plane function (UPF) of the core network;
process a user datagram protocol (UDP) header of the third packet; and
process an IP header of the third packet; and
the one or more second processors are configured to execute the second processor-executable instructions and further cause the NTN payload to:
process a service data adaptation protocol (SDAP) header of a fourth packet communicated between the NTN payload and the UE;
process a PDCP header of the fourth packet;
process an RLC protocol header of the fourth packet; and
process a MAC header of the fourth packet.

14. The NTN system of claim 12, wherein:
the one or more first processors are configured to execute the first processor-executable instructions and further cause the NTN gateway to:
process an NGAP or Xn header of a third packet communicated between the NTN gateway and the NTN payload;
process an SCTP header of the third packet; and
process an IP header of the third packet.

15. The NTN system of claim 12, wherein:
the one or more first processors are configured to execute the first processor-executable instructions and further cause the NTN gateway to:
process an NGAP or Xn header of a third packet communicated between the NTN gateway and the NTN payload;
process a user datagram protocol (UDP) header of the third packet; and
process an IP header of the third packet.

16. The NTN system of claim 12, wherein the one or more first processors are configured to execute the first processor-executable instructions and further cause the NTN gateway to:
receive information comprising user plane data, control plane signaling, or UE context information of the UE from the NTN payload; and
send the information to a second NTN payload.

17. The NTN system of claim 12, wherein the one or more second processors are configured to execute the second processor-executable instructions and further cause the NTN payload to:
store data of the UE at a first time when a link between the NTN payload and the NTN gateway is unavailable; and
send the data to the NTN gateway at a second time when the link between the NTN payload and the NTN gateway is available.

18. The NTN system of claim 12, wherein the one or more second processors are configured to execute the second processor-executable instructions and further cause the NTN payload to:
send to the UE an indication of communication delay between the NTN gateway and the NTN payload on the SRI.

19. A method for wireless communication by a non-terrestrial network (NTN) gateway, comprising:
communicating with an access and mobility management function (AMF) of a core network;
receiving a path switch request message from a target NTN payload, the path switch request message indicating to switch a downlink data path of a user equipment (UE) from a source NTN payload to the target NTN payload;
after receiving the path switch request message, sending a path switch request acknowledge message to the target NTN payload; and
after sending the path switch request acknowledge message, communicating user data of the UE with the target NTN payload.

20-30. (canceled)
